(19) United States
(12) Patent Application Publication
(10) Pub. No.: US 2011/0124252 A1
(43) Pub. Date: May 26, 2011

(54) PROCESS FOR PRODUCING CONDUCTIVE FILM AND CONDUCTIVE FILM

(75) Inventors: Masatsugu Shimomura, Sendai-shi (JP); Hiroshi Yabu, Sendai-shi (JP); Yuji Hirai, Sendai-shi (JP); Takanori Hattori, Suita-shi (JP); Takaharu Fujita, Osaka-shi (JP)

(73) Assignee: Nippon Shokubai Co., Ltd, Osaka-shi (JP)

(21) Appl. No.: 12/737,350

(22) PCT Filed: Jun. 24, 2009
(86) PCT No.: PCT/JP2009/061531

§ 371 Date: Jan. 3, 2011

(30) Foreign Application Priority Data
Jul. 2, 2008 (JP) 2008-173987

(51) Int. Cl. H01B 1/00; B05D 5/12; D03D 19/00

(52) U.S. Cl. 442/1; 427/58; 252/500

(57) ABSTRACT

The present invention has an object to provide a process for producing a conductive film, which enables low-cost, easy production of conductive mesh films that have a fine mesh structure and can prevent moiré patterns when used in displays and the like, and a conductive film. The production process includes applying an organic solvent dispersion containing conductive fine particles to a substrate; and evaporating the organic solvent while condensing water vapor in air into water droplets on the surface of the applied organic solvent dispersion. The conductive film has a mesh shape and the mesh shape is formed by mesh lines made of a conductive material and holes. The average area of the holes is not more than 400 μm², and the mesh lines each have a width of not more than 5 μm.

### TECHNICAL FIELD

The present invention relates to a process for producing a conductive film and a conductive film. More specifically, the present invention relates to a process for producing a conductive film suitably used in flat panel displays such as liquid crystal displays, plasma displays, and electronic paper (digital paper), and touch panels, and also relates to a conductive film.

### BACKGROUND ART

Conductive films are extending its application to electronic devices of various types. With a recent growing demand for flat panel displays, especially for liquid crystal displays, plasma displays, and electronic paper (digital paper), a demand for conductive films with excellent light transmittance and conductivity for these uses is growing, and the research and development of such films have become more active.

At present, for light-transmitting conductive films, indium tin oxide (ITO) is commonly used. Conductive films made of indium tin oxide have well-balanced light transmittance and conductivity, and are used, for example, in touch panels as well as in general liquid crystal displays. However, since rare metals such as indium are expensive and may be depleted, there is a need for light-transmitting conductive films made of a lower-cost material that is less likely to be depleted. In addition, the productivity of these films is low because methods such as sputtering are commonly used to form an ITO coat. Thus, these films should be improved in terms of productivity.

As examples of light-transmitting conductive films, are mentioned conductive films made of a light-transmitting conductive material such as indium tin oxide; and mesh-patterned conductive films. As examples of the mesh-patterned conductive films and production processes thereof, the following are disclosed: a transparent conductive film including a metallic ultrafine particle catalyst layer formed in a predetermined pattern on a transparent substrate and a metal layer formed on the metallic ultrafine particle catalyst layer, wherein the ratio of the average pore size and the average line width of the pattern (average pore size/average line width) is not less than 7, and a process for producing a transparent conductive film, which includes pattern-printing a paste containing an electroless plating catalyst on a transparent substrate, and performing electroless plating treatment on the pattern-printed electroless plating catalyst to form a metal layer only on the pattern-printed part (see, for example, Patent Document 1); a process for producing a light transmitting electromagnetic wave shielding film having a conductive metal part and a light transmission part, which includes exposing a silver salt-containing layer containing a silver salt formed on a supporting body to light, developing it to form a metal silver part and the light transmission part, and physically developing and/or plating the metal silver part to form the conductive metal part in which conductive metallic particles are supported on the metal silver part (see, for example, Patent Document 2); and an electromagnetic wave shield material including a transparent substrate and a thin line pattern formed thereon wherein the thin line pattern is comprised of a metal plating film formed using, as catalyst nuclei, metal silver resulting from physical development, and a process for producing an electromagnetic wave shield material, which includes exposing, to light, a light sensitive material formed on a transparent substrate and having a physical development nuclei layer and a silver halide emulsion layer in the following order, carrying out physical development processing so as to deposit metal silver in any thin line pattern on the physical development nuclei layer, removing the layer provided on the physical development nuclei layer, and performing metal plating with the use of the metal silver resulting from the physical development as catalyst nuclei (see, for example, Patent Document 3).

Mesh-patterned conductive films produced by these processes are used as electromagnetic wave shield films (EMI shield films) and the like. These films, however, still need to be improved for further thinner lines to achieve higher transmittance and prevent moiré patterns. In addition, their light transmittance is so low that the use of them as transparent electrodes for displays and the like is difficult. Further, these films needs to be improved in terms of productivity as well because they require a complicated lithography step for forming a pattern.

For example, as a process for forming a mesh-patterned conductive coat, disclosed is a process for forming a transparent conductive coat containing metal nanoparticles, which includes (a) mixing, in an organic solvent, the metal nanoparticles and at least one component selected from the group consisting of binders, surfactants, additives, polymers, buffers, dispersants, and coupling agents into a homogenous mixture; (b) applying the resulting homogeneous mixture to a surface to be coated; (c) evaporating the solvent from the homogeneous mixture; and (d) sintering the coat on the surface to form a transparent conductive coat on the surface (see, for example, Patent Document 4). For example, Patent Document 5 discloses a conductive substrate having a random mesh layer, wherein a metallic fine particle layer is laminated in a random mesh pattern on at least one side of a substrate, a plated metal layer is laminated on the metallic fine particle layer, the thickness of the plated metal layer formed at least one side surface of the conductive substrate is not less than 1.5 μm, the total light transmission ratio of the conductive substrate is more than 65%, and the surface specific resistance of at least one side surface of the conductive substrate is smaller than 0.5 Ω/sq.

As examples of a process for producing an organic film having a porous structure, the following processes are disclosed: a process for producing a honeycomb-patterned porous material, which includes preparing a polymer solution by dissolving a linear polymer in a solvent, condensing water vapor in the atmosphere into water droplets by cooling the polymer solution, and allowing part of the liquid droplets to permeate from the surface into the inside of the polymer solution, and evaporating the solvent and removing the liquid droplets (see, for example, Patent Document 6); and a honeycomb-patterned organic film (see, for example, Non-Patent Document 1). All of these processes utilize organic polymer films and application thereof to conductive films is not described.

For example, Patent Document 7 discloses a transparent electrode wherein a linear part made of a conductive metal is provided in a two-dimensional net-work pattern on a substrate and the ratio of the area occupied by the linear part to the area of the whole surface of the substrate is 20% or less. This document was published after the basic application of the present invention. This document also discloses a process for producing a transparent electrode, which includes: a drying step of forming a transparent electrode precursor by applying, to a transparent substrate, a coating liquid prepared by dispersing conductive metal fine particles in an organic solvent and drying the substrate at a high humidity; and a firing step of firing the transparent electrode precursor. The document describes that silver nanoparticles were used in Examples, that the SEM image of FIG. 2 captured after firing shows that the transparent electrode had lost a regular mesh structure but had a two-dimensional net work formed on the surface, and that the area of holes on the surface of the transparent electrode was 92.8% of the entire surface area.

As is described in the document, the SEM image of FIG. 2 captured after firing shows that the electrode had lost a regular mesh structure. Also, the “two-dimensional net work” cannot be confirmed in the image and only irregular projections and depressions are observed over the entire surface. Such a structure could not ensure a sufficient hole area.

### PRIOR ART DOCUMENT

### Patent Document

Patent Document 1: JP-A 2003-109435 (page 1-2)

Patent Document 2: JP-A 2004-221564 (page 1-2)

Patent Document 3: WO 2004/007810 (page 1-2)

Patent Document 4: JP-A 2005-530005 (page 1-2)

Patent Document 5: JP-A 2007-227906 (page 1-2)

Patent Document 6: JP-A H08-311231 (page 1-2)

Patent Document 7: JP-A 2008-243547 (page 1, 2, 8-11)

### [Non-Patent Document]

Non-Patent Document 1: Jin Nishida, Kazutaka Nishikawa, Shin-Ichiro Nishimura, Shigeo Wada, Takeshi Karino, Takehiro Nishikawa, Kuniharu Ijiro, and Masatsugu Shimomura, Polymer Journal, 2002, Vol. 34, No. 3, pp 166-174

### SUMMARY OF THE INVENTION

### Problems to be Solved by the Invention

However, processes including plating after applying an ink containing metal nanoparticles by gravure printing have a problem that it is difficult to form thin mesh lines, and processes for producing a mesh film by a developing process using a silver salt have problems that multiple steps such as removal of excess metal and plating are required after formation of a pattern by light exposure, and that it is difficult to form thin mesh lines. Thus, these processes need to be improved.

In addition, processes including adding water in a silver nanoparticle-containing organic solvent dispersion beforehand, and forming a pattern have a problem that nanodispersion is difficult due to aggregation of water and the like. Accordingly, it is impossible to produce films having a narrow line width and a fine mesh structure by such processes. In addition, another problem of these processes is that the stability of the ink is deteriorated by water added beforehand. Thus, these processes need to be improved.

The transparent electrode disclosed in Patent Document 7 (published after the basic application of the present invention) lost a regular mesh structure through firing, as described above, and therefore the production process for the same is not a process for producing a conductive mesh film. In addition, as also shown in a reference example described below, a silver coat with projections and depressions was formed over the entire surface and the entire surface had no hole and therefore was not transparent. Accordingly, there is no conventional technique teaching production of conductive mesh films, and solution of these problems will be a technically big advance in technical fields in which conductive materials such as conductive films are used, and will enable use of such films for various purposes such as liquid crystal displays, plasma displays, and electronic paper (digital paper).

In view of the above-mentioned problems, an object of the present invention is to provide a process for producing a conductive mesh film, which enables easy and low-cost production of conductive mesh films that have a fine mesh structure and can prevent moiré patterns and the like when used for displays and the like, and a conductive film.

### Means for Solving the Problems

The present inventors examined various processes for producing a conductive film from conductive materials such as metals and focused on the fact that a conductive film having mesh lines made of a conductive material and holes has light transmittance and conductivity. However, when such a film is produced by conventional techniques such as the process including forming a random mesh layer in which a plated metal layer is laminated on a metallic fine particle layer, the production costs will be disadvantageously greater. In addition, the productivity needs to be improved. In the case of the process including adding water in an organic solvent dispersion beforehand and forming a pattern, it may be impossible to form thin lines and a fine mesh structure, and the stability of the ink will be low.

The present inventors found that, unlike the above conventional techniques, a process for producing a conductive film, which includes evaporating an organic solvent while condensing water vapor in air (in the atmosphere) into water droplets on the surface of an applied organic solvent dispersion containing conductive fine particles enables easy and low-cost production of conductive mesh films and also can improve the productivity. The present inventors also found that conductive films produced by this process have a fine mesh structure with thin lines, and thus completed the present invention. Conductive mesh films will be novel means for imparting conductivity among conductive materials which have experienced a sharp increase in demand and are extending their application fields in these years. These films will be able to be used in various fields.

One preferable embodiment of the present invention is described below. FIG. 1-1 is a schematic view illustrating a transition of the cross-section of a coat of an applied organic solvent dispersion over time in one example of the step of evaporating an organic solvent while condensing water vapor in air into water droplets on the surface of the coat. Time flows from left to right in FIG. 1-1. Since, as shown in FIG. 1-1, droplets 13 form on the surface of an organic solvent dispersion applied to the substrate 11 (hereinafter, also referred to as “coat”) and then captured in the coat 12 without aggregating together. Then, the organic solvent and the droplets are evaporated and thus a conductive mesh film is formed. Thus, the production steps of this process are easy and require low costs, and this process can also improve the productivity.

Specifically, the present invention provides a process for producing a conductive mesh film, including: applying an organic solvent dispersion containing conductive fine particles to a substrate; and evaporating the organic solvent while condensing water vapor in air into water droplets on a surface of the applied organic solvent dispersion.

The present invention also provides a conductive film having a mesh shape, wherein the mesh shape is formed by mesh lines made of a conductive material and holes, the average area of the holes is not more than 400 μm², and the mesh lines each have a width of not more than 5 μm.

Hereinafter, the present invention is described in more detail.

The process for producing a conductive film of the present invention is a process for producing a conductive mesh film by applying an organic solvent dispersion containing conductive fine particles to a substrate. Compared to processes such as sputtering and processes including plating, this process enables easier, lower-cost production of films. Thus, this process can reduce the production costs and improve the productivity. Hereinafter, the coat of the organic solvent dispersion applied to the substrate is also referred to as “coat”.

The mesh lines and the holes of the conductive mesh film may be arranged at random or may be arranged in a regular manner. Some examples of the arrangement are illustrated, for example, in FIGS. 6 to 10 and will be described later. These figures each illustrate a structure that is considered as a whole as a mesh structure in microtechnology fields although larger holes and smaller holes coexist and some lines are discontinuous. Namely, they may be arranged in any manner as long as they form a structure that is considered as a mesh structure by microscopic observation. Preferably, the mesh structure is formed over the entire surface of the conductive film. However, the area of the mesh structure may be appropriately determined according to the intended use of the conductive film, and the mesh structure may cover only a part of the film as long as the film can exhibits its functions as a conductive film. Other preferred mesh structures will be described later.

In contrast, the transparent electrode and the production process for the same of Patent Document 7 are evaluated that they lost a mesh structure, as shown in FIG. 2 in the document. This fact can be confirmed by FIG. 15, which will be described later. Like later-described Reference Example 3 in which silver particles precipitate at the bottom of holes of a mesh structure, films that are considered not to include a part in which the substrate can be directly observed are also not considered as conductive mesh films.

The above-mentioned process for producing a conductive film includes the steps of evaporating the organic solvent while condensing water vapor in air into water droplets on the surface of the applied organic solvent dispersion. This process enables formed droplets to be captured in the coat while the organic solvent is evaporated. After the evaporation of the organic solvent, by drying the captured droplets, holes corresponding to the captured droplets are formed. In this way, the mesh lines made of conductive fine particles and the holes are formed. Thus, the process for producing a conductive film of the present invention enables low-cost, easy production of conductive mesh films having excellent transmittance and conductivity. Accordingly, conductive films produced by the above-mentioned process for producing a conductive film preferably have a mesh structure formed by mesh lines and holes.

The above-mentioned process for producing a conductive film includes the step of evaporating the organic solvent while condensing water vapor in air into water droplets on the surface of the applied organic solvent dispersion. Condensing water vapor in air into water droplets on the coat surface can be performed by adjusting the humidity around the coat surface and the temperature difference between the atmosphere around the coat surface and the coat surface. Namely, these conditions are determined so that droplets form on the coat surface. In the present invention, conductive units and holes are formed in a mesh pattern on the surface of the coat. It is technically clear that this structure is achieved by the mechanism illustrated in FIG. 1-1, that is, by evaporating the organic solvent while condensing water vapor in air into water droplets on the coat surface.

In other words, from this fact, the process for producing a conductive film of the present invention includes the step of evaporating the applied organic solvent under conditions under which droplets form on the coat surface. Examples of the “conditions under which droplets form on the coat surface” include a condition in which the dew point of the atmosphere in which the organic solvent is evaporated is higher than the temperature of the coat surface. Droplets may be formed by any method, and suitable examples thereof include a method in which the temperature of the coat surface is cooled to a temperature not higher than the dew point of the atmosphere in which the organic solvent is evaporated; and a method in which the atmosphere in which the organic solvent is evaporated is humidified so that the dew point of this atmosphere is raised to a temperature higher than the temperature of the coat surface. Any of these methods may be employed alone, or two or more of these may be employed in combination. A combination of these methods enables more precise control of the conditions under which the organic solvent is evaporated and therefore enables adjustment of the shape of a conductive film to be produced.

The temperature of the coat surface may be decreased by any method to a temperature not higher than the dew point of the atmosphere in which the organic solvent is evaporated, and examples thereof include a method in which the coat is forcibly cooled with a cooling element or the like; and a method in which the temperature of the coat surface is lowered by the evaporation latent heat of the organic solvent. As the method in which the coat is forcibly cooled with a cooling element or the like, preferable is a method including cooling the substrate to which the organic solvent dispersion has been applied so that the temperature of the coat surface is also decreased. Such a cooling method increases the difference between the temperature of the coat surface and the temperature of the atmosphere in which the organic solvent is evaporated and therefore droplets are more likely to form. Namely, the temperature of the coat surface is preferably lowered to a temperature lower than the temperature of the atmosphere in which the organic solvent is evaporated. One of suitable examples thereof is a method in which the substrate to which the organic solvent dispersion has been applied is cooled with a cooling instrument such as a Peltier device. This method enables independent control of the temperature of the coat surface and the atmosphere around the coat in which the organic solvent is evaporated, and therefore enables more precise setting of the conditions. More precise adjustment of the conditions enables control of characteristics of a conductive film to be produced such as shape, transmittance, and conductivity, and therefore enables production of conductive films having shapes suited for various usages.

In order to form droplets on the coat surface while the organic solvent is evaporated, the atmosphere is preferably humidified. Namely, the step of evaporating the organic solvent is preferably a step of evaporating the organic solvent in a humidified atmosphere. In a humidified atmosphere, droplets are likely to form on the surface of the organic solvent dispersion. Suitable examples of a method for raising the dew point of the atmosphere in which the organic solvent is evaporated than the temperature of the coat surface by humidifying the atmosphere include a method in which the entire atmosphere in which the organic solvent is evaporated is humidified; and a method in which a humidifying gas is applied to the coat surface. In a humidified atmosphere, droplets are likely to form on the coat surface. In the case of applying a humidifying gas to the coat surface, the shape and number of droplets to be captured in the coat will change according to factors such as the applying rate. Therefore, the conditions under which the organic solvent is evaporated can be adjusted by adjusting the applying rate. In this way, the shape of the conductive film can be controlled and therefore its characteristics (e.g. light transmittance, conductivity) can be improved. The humidified atmosphere may be any atmosphere as long as it is in the similar conditions as those created by humidifying, that is, the humidity of the atmosphere is high enough to allow formation of droplets on the surface of the coat of the organic solvent dispersion. The step of evaporating the organic solvent may be performed by humidifying or in an atmosphere with a high humidity.

The relative humidity of the humidified atmosphere is preferably not lower than 50%. At relative humidities of not lower than 50%, droplets are likely to form on the coat surface, and therefore the efficiency of production of conductive films will be high. The relative humidity is more preferably not lower than 55%, and further more preferably not lower than 60%.

The upper limit of the applying wind speed of the humidifying gas is preferably not more than 5 m/s (300 m/min) in terms of the flow rate. If the humidifying gas is applied at a flow rate of more than 5 m/s, the applied organic solvent dispersion may be deformed by the applied humidifying gas and the film may not have a desired shape after drying the organic solvent. The upper limit of the applying wind speed of the humidifying gas is more preferably not more than 3 m/s (180 m/min), and further more preferably not more than 1 m/s (60 m/min) in terms of the flow rate. The lower limit of the wind speed is preferably not less than 0.02 m/min. If the flow rate is not more than 0.02 m/min, sufficient droplets may not be captured in the applied organic solvent dispersion. The lower limit of the wind speed is more preferably 0.1 m/min, and further more preferably not less than 0.2 m/min, and particularly preferably not less than 0.4 m/min in terms of the flow rate. In view of the productivity, the upper limit of the time period for applying the humidifying gas is preferably not longer than 1 hour, more preferably not longer than 40 minutes, and further more preferably not longer than 30 minutes. The lower limit of the time period for applying the humidifying gas is preferably not shorter than 1 minute. If the time period is shorter than 1 minute, the organic solvent may not be sufficiently evaporated, and sufficient droplets may not be captured in the organic solvent dispersion. The time period is more preferably not shorter than 5 minutes, and further more preferably not shorter than 10 minutes. The time period is suitably, for example, about 20 minutes (15 to 25 minutes). The relative humidity of the humidifying gas to be applied is preferably in the same range as the above-mentioned range and specifically is preferably not lower than 50%, more preferably not lower than 55%, and particularly preferably not lower than 60%.

Here, the process for producing a conductive film is described using FIGS. 1-2. FIGS. 1-2 are flow views illustrating the step of evaporating the organic solvent while condensing water vapor in air into water droplets on the surface of the applied organic solvent dispersion. As shown in FIG. 1-2(a), the organic solvent dispersion applied to the substrate 11 (hereinafter, also referred to as “coat”) is exposed to conditions under which droplets form on the coat surface, by cooling the substrate 11 having the coat 12 formed thereon or applying the humidifying gas. As a result, as shown in FIG. 1-2(b), droplets form on the coat surface. The formed droplets 13 are captured in the coat 12, as shown in FIGS. 1-2(c) and 1-2(d). As the organic solvent evaporates over time, the applied organic solvent dispersion becomes thin. After the organic solvent and droplets captured in the humidified atmosphere evaporate, the film from which the organic solvent has been evaporated has holes 14 and mesh lines 15 formed therein, as shown in FIG. 1-2(e). Thus, a mesh pattern is formed. FIG. 2 is a plane view schematically illustrating the shape of the film after evaporation of the organic solvent. In the film, the mesh lines 15 containing a metal are formed around the formed holes 14. Films produced to have such a structure have conductivity and transmittance.

The process in which the organic solvent is evaporated by cooling the substrate 21 and the coat 22 with a Peltier device 20 and applying the humidified gas to the applied organic solvent dispersion, as shown in FIG. 3, is one suitable embodiment of the process for producing a conductive film of the present invention. Namely, the above-mentioned production process preferably includes the step of evaporating the organic solvent while condensing water vapor in air into water droplets on the coat surface by cooling the substrate and the coat and applying the humidified gas to the coat.

The “conductive fine particles” mean typical conductive particles having an average particle size of not more than 100 μm. The particle size of the conductive fine particles is not particularly limited and the average particle size thereof is preferably not more than 1 μm. The use of conductive fine particles having an average particle size of not more than 1 μm enables production of transparent conductive films having thin conductive mesh lines and wide transmitting parts, that is, transparent conductive films with a high aperture ratio. Such transparent conductive films have enhanced transmittance. The average particle size of the conductive fine particles is more preferably not more than 500 nm, further more preferably not more than 100 nm, still further more preferably not more than 50 nm, and particularly preferably not more than 10 nm. Especially, conductive fine particles having an average particle size of not more than 10 nm can enhance the conductivity of the conductive mesh lines. With respect to metal particles, the smaller the particle size, the lower the melting point. Therefore, metal particles having small particle sizes may be fused with each other at a low firing temperature and provide conductivity. The particle size distribution is preferably not more than 30%, more preferably not more than 20%, and further more preferably not more than 15% when expressed in terms of the coefficient of variation.

The average particle size may be the number average particle size that is determined from TEM images (transmission electron microscopic images) or SEM images (scanning electron microscopic images); the crystallite size determined by powder X-ray diffraction measurement; the average particle size that is determined from the radius of inertia and the scattering intensity thereof determined by a method such as X-ray small angle scattering; or the like. Among these, the number average particle size determined from SEM images (scanning electron microscopic image) is preferable.

The shape of the conductive fine particles is not limited to sphere shapes and other suitable examples thereof include oval sphere shapes, cubes, cuboids, pyramids, needle-like shapes, columnar shapes, cylindrical shapes, tubular shapes, scale-like shapes, thin plate-like shapes such as plate shapes (e.g. hexagonal plate shapes), and cord-like shapes.

The conductive fine particles are not particularly limited as long as they are fine particles containing a conductive material. Examples thereof include metal fine particles, fine particles made of a conductive inorganic oxide, fine particles made of a carbon-containing material, and fine particles made of a carbide-based material. The metal may be any of various types of metals and may be any of simple metals, alloys, solid solutions, and the like. The metal elements are not particularly limited and examples thereof include various metals such as platinum, gold, silver, copper, aluminum, chromium, cobalt, and tungsten. Among these, highly conductive metals are preferable. Preferable examples of the highly conductive metals include metals containing at least one selected from the group consisting of platinum, gold, silver, and copper. Preferable examples of the metals include metals with high chemical stability. For example, in the case of the process for producing a conductive film described above, steps of dispersing the conductive fine particles in the organic solvent and drying the organic solvent are performed. Therefore, metals capable of avoiding oxidization, corrosion, and the like in these steps are preferable. For high chemical stability, the metals preferably contain at least one selected from the group consisting of platinum, gold, and silver. Among these, for cost savings, metals containing silver are preferable. Examples of the conductive inorganic oxide include indium-containing oxides such as indium tip oxide; transparent conductive materials such as zinc oxide-based oxides; and non-transparent conductive inorganic oxides. Examples of the carbon-containing material include carbon black. Examples of the carbide-based materials include silicon carbide, chromium carbide, and titanium carbide. As the conductive fine particles, fine particles in which a non-conductive fine particle is covered with a conductive material selected from the materials described above for the conductive fine particles (e.g. metals, conductive inorganic oxides, carbon-containing materials, carbide-based materials) are also preferably used (e.g. fine particles with a core-shell structure composed of a “non-conductive material” (core) and a “conductive material” (shell)). The non-conductive fine particles are not particularly limited and may be non-conductive fine particles made of various materials. Fine particles of an oxide such as silver oxide or copper oxide may also be used. In this case, a dispersion prepared by dispersing the fine particles in the organic solvent is applied, and the coated film is left in a reduction atmosphere so that the metal oxide is reduced to the metal such as silver or cupper. Namely, the above-mentioned process for producing a conductive film which includes dispersing the oxide fine particles in the organic solvent; applying the dispersion; and leaving the coated film in a reduction atmosphere so that the metal oxide is reduced to the metal is also a preferable embodiment.

The organic solvent dispersion is a dispersion in which the conductive fine particles are dispersed in the organic solvent, and may contain materials other than the organic solvent and the conductive fine particles. The organic solvent is not particularly limited and may be selected from organic solvents of various types.

Examples of the organic solvent include aromatic hydrocarbons such as benzene-based hydrocarbons including benzene, toluene, o-xylene, m-xylene, p-xylene, mixtures of xylenes, ethyl benzene, hexyl benzene, dodecyl benzene, and phenyl xylyl ethane; aliphatic hydrocarbons such as paraffinic hydrocarbons (e.g. n-hexane, n-decane), isoparaffinic hydrocarbons (e.g. Isopar (product of exxon chemicals)), olefinic hydrocarbons (e.g. 1-octene, 1-decene), and naphthenic hydrocarbons (cyclohexane, decalin); petroleum-derived or coal-derived hydrocarbon mixtures such as kerosene, petroleum ether, petroleum benzine, ligroin, industrial gasoline, coal tar naphtha, petroleum naphtha, and solvent naphtha; halogenated hydrocarbon such as dichloromethane, chloroform, carbon tetrachloride, 1,2-dichloroethane, 1,1,1-trichloroethane, 1,1,2,2-tetrachloroethane, trichlorofluoroethane, tetrabromoethane, dibromotetrafluoroethane, tetrafluorodiiodoethane, 1,2-dichloroethylene, trichloroethylene, tetrachloroethylene, trichlorofluoroethylene, chlorobutane, chlorocyclohexane, chlorobenzene, o-dichlorobenzene, bromobenzene, iodinemethane, diiodomethane, and iodoform; esters such as ethyl acetate and butyl acetate; ketones such as acetone, methyl ethyl ketone, and methyl isobutyl ketone; alcohols such as methanol, ethanol, isopropanol, octanol, and methyl cellosolve; silicone oils such as dimethyl silicone oil and methylphenyl silicone oil; fluorine-containing solvents such as hydrofluoroether; and carbon bisulfide. Any of these organic solvents may be used alone, or two or more of these may be used in combination.

The organic solvent is preferably a hydrophobic organic solvent. In the case of a hydrophobic organic solvent, droplets formed in a humidified atmosphere can be captured in the organic solvent dispersion in a more stable form. The organic solvent is preferably a non-polar organic solvent. Non-polar organic solvents are less likely to dissolve in water, which is composed of polar molecules. Therefore, in the case of a non-polar organic solvent, droplets captured in the coat can be maintained in a further suitable form. Preferable examples of the non-polar organic solvents include aromatic hydrocarbon solvents having about 6 to 10 carbons such as benzene, toluene, xylenes, hexane, and cyclohexane; halogenated hydrocarbon solvents such as chloroform and dichloromethane; and aliphatic hydrocarbon solvents. In view of the evaporation rate and the solubility to water of the organic solvent, in other words for comparatively higher evaporation rate, tendency to form droplets, and immiscibility with water, benzene, toluene, hexane, cyclohexane, and the like are more preferable. The organic solvent may be a mixed solvent of a polar solvent and a nonpolar solvent. Examples thereof include mixed solvents of an aromatic hydrocarbon solvent and a ketone solvent, and mixed solvents of an aromatic hydrocarbon and an amide-based solvent.

The specific gravity of the organic solvent is preferably not more than the specific gravity of water. If the specific gravity of the organic solvent is larger than the specific gravity of water, droplets formed on the coat surface may not be captured in the organic solvent dispersion. Specifically, the specific gravity of the organic solvent at room temperature (20° C.) is preferably not more than 1.00, more preferably not more than 0.95, and further more preferably not more than 0.90.

The viscosity of the organic solvent at room temperature (20° C.) is preferably not more than 2 mPa·s. If the viscosity of the organic solvent is too high, sufficient droplets may not be captured in the applied organic solvent dispersion.

The organic solvent dispersion preferably contains an amphiphilic compound miscible with water and the organic solvent. If an amphiphilic compound is contained therein, droplets captured in the coat can be easily maintained in a suitable shape due to the surface active function of the compound, resulting in, for example, prevention of aggregation of droplets. The amphiphilic compound is not particularly limited and may be a low-molecular-weight amphiphilic compound or may be a high-molecular-weight amphiphilic compound. For higher surface active function, high-molecular-weight amphiphilic compounds are preferable. In order to maintain droplets captured in the coat of the organic solvent dispersion in a suitable shape, a compound having the surface active function is preferably used. Namely, the organic solvent dispersion containing a compound having the surface active function is one preferable embodiment of the present invention.

The amount of the amphiphilic compound is preferably 0.001 to 25% by mass per 100% by mass of the organic solvent dispersion. If the amount is within this range, the shape of droplets captured in the applied organic solvent dispersion can be maintained more stably. If the amount is less than 0.001% by mass, growth and movement of droplets on the coat surface may be difficult, resulting in a low aperture ratio. If the amount is more than 25% by mass, droplets may aggregate on the coat surface, resulting in poor formation of holes. In addition, conductivity is less likely to be exerted. The amount of the amphiphilic compound is more preferably 0.001 to 15% by mass, further more preferably 0.001 to 5% by mass, and particularly preferably 0.01 to 1% by mass.

The amphiphilic compound is preferably a compound which has both a hydrophilic group and a hydrophobic group. Addition of the amphiphilic compound is aimed at prevention of aggregation of droplets attached to the organic solvent dispersion applied to the substrate. The amphiphilic compound is not particularly limited as long as it is a compound having moieties miscible with water and the organic solvent. Examples of hydrophobic groups include non-polar groups such as C₅₋₂₀ hydrocarbon groups, phenyl group and phenylene group. Examples of hydrophilic groups include hydroxyl group, carboxyl group, amino group, carbonyl group, sulfo group, ester group, amide group, and ether group.

Examples of the amphiphilic compound include anionic surfactants such as sodium alkyl sulfates; cationic surfactants such as alkyl ammonium chlorides; nonionic surfactants such as polyoxyethylene alkyl ethers and sorbitan fatty acid esters; alkylamines such as octylamine and dodecylamine; and amphiphilic polymers. In view of the solubility to the organic solvent and water, the nonionic surfactants and the amphiphilic polymers are preferable. Any of these amphiphilic compounds may be used alone, or two or more of these may be used in combination.

Examples of the amphiphilic polymers include polymers having a polyacrylamide as the main chain backbone, and a hydrophilic group and a hydrophobic group in side chains; copolymers of a hydrophobic (meth)acrylate and a hydrophilic (meth)acrylate; copolymers of polystyrene and a hydrophilic (meth)acrylate; polymers having a hydrophilic group in the main chain and a hydrophobic group in a side chain such as octadecyl isocyanate modified polyethyleneimine (EPOMIN RP-20, product of Nippon Shokubai Co., Ltd.); block copolymers of polyethylene glycol having a hydrophobic group and a hydrophilic group and polypropylene glycol; and polysulfones that are produced by polycondensation of dichlorodiphenylsulfone and the sodium salt of bisphenol A and have a diphenylene dimethyl methylene group, which is a hydrophobic group, and a diphenylene sulfone group, which is a hydrophilic groups, in the main chain backbone.

The weight average molecular weight of the amphiphilic polymer is preferably not less than 5000. When an amphiphilic polymer having a weight average molecular weight of not less than 5000 is used, the pattern structure is likely to be preserved well through evaporation of the solvent and firing. The weight average molecular weight is more preferably not less than 10000, further more preferably not less than 50000, and particularly preferably not less than 90000. The number average molecular weight of the amphiphilic polymer is preferably not less than 3000. When an amphiphilic polymer having a number average molecular weight of not less than 3000 is used, the pattern structure is likely to be preserved well through evaporation of the solvent and firing. The number average molecular weight of the amphiphilic polymer is more preferably not less than 5000, furthermore preferably not less than 10000, and particularly preferably not less than 20000.

The weight average molecular weight and the number average molecular weight can be defined, for example, as the molecular weight (versus polystyrene standards) determined using gel permeation chromatography (GPC) HLC-8120 (product of Tosoh Corp.) as a measuring device and TSK-GEL GMHXL-L (product of Tosoh Corp.) as a column.

Preferable examples of the polymers having polyacrylamide as a main chain backbone, and a hydrophilic group and a hydrophobic group in side chains include (dodecylacrylamide)ₙ-(ω-carboxyhexylacrylamide)ₘ-random copolymers (hereinafter, also referred to as “CAP”) represented by the formula:

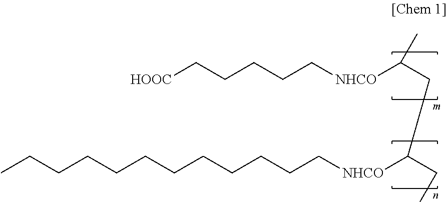

In the formula, n and m may be the same as or different from each other and each represent the number of the repeating constitutional units.

In the formula, the ratio of n to m (n/m) is preferably 1 to 15, more preferably 2 to 12, and further more preferably 3 to 10.

Examples of the hydrophobic (meth)acrylate include normal hexyl (meth)acrylate, cyclohexyl (meth)acrylate, phenyl (meth)acrylate, heptyl (meth)acrylate, benzyl (meth)acrylate, octyl (meth)acrylate, 2-ethylhexyl (meth)acrylate, nonyl (meth)acrylate, decyl (meth)acrylate, lauryl (meth)acrylate, myristyl (meth)acrylate, palmityl (meth)acrylate, and stearyl(meth)acrylate.

Examples of the hydrophilic (meth)acrylate include (meth)acrylic acid, 2-hydroxyethyl (meth)acrylate, 2-hydroxypropyl(meth)acrylate, 4-hydroxybutyl(meth)acrylate, dimethylaminoethyl (meth)acrylate, diethylaminoethyl (meth)acrylate, 2-(meth)acryloyloxyethyl succinate, 2-(meth)acryloyloxyethyl 2-hydroxypropyl phthalate, glycidyl (meth)acrylate, 2-(meth)acryloyloxyethyl acid phosphate, and caprolactone modified (meth)acrylate.

Instead of the hydrophobic (meth)acrylate, hydrophobic radical polymerizable monomers such as hydrophobic (meth)acrylamide and styrene may be used. Instead of the hydrophilic (meth)acrylate, hydrophilic radical polymerizable monomers such as hydrophilic (meth)acrylamide and N-vinyl pyrrolidone may be used.

Any of the hydrophobic (meth)acrylates and hydrophilic (meth)acrylates may be used alone, or two or more of these may be used in combination. Alternatively, other components may be contained.

The amount of the conductive fine particles is preferably 0.05 to 10% by mass per 100% by mass of the organic solvent dispersion. If the amount is more than 10% by mass, the conductive fine particles may aggregate in the organic solvent dispersion and may not be sufficiently dispersed. Amounts of less than 0.05% by mass are too small and the conductive fine particles in such an amount may not provide a sufficient level of conductivity. The amount of the conductive fine particles is more preferably 0.1 to 10% by mass, and further more preferably 0.2 to 10% by mass.

The water content of the organic solvent dispersion before application is preferably not more than 10% by mass. If the water content of the organic solvent dispersion before application is high, moisture in the organic solvent dispersion grows into larger droplets due to the surface tension, and therefore it may be impossible to form a fine mesh structure. The water content before application is more preferably not more than 5% by mass.

The organic solvent dispersion is applied to the substrate. The substrate is not particularly limited as long as the organic solvent dispersion can be applied to the surface thereof. Examples of the substrate include substrates of various types such as glass substrates, plastic substrates, single crystal substrates, semiconductor substrates, and metal substrates. Suitable substrates for displays such as electric paper (digital paper) include transparent substrates such as glass substrates and transparent plastic substrates. The “transparent substrates” mean substrates with high visible light transmittance, and examples thereof include substrates with a transmittance for visible light with a wavelength of 400 to 700 nm of not less than 50%. The transmittance is more preferably not less than 70%, and further more preferably not less than 80%. The use of glass substrates and plastic substrates is preferable in terms of cost savings. For display devices such as electric paper, flexible substrates are also preferable. Examples of the plastic substrates include films made of the following materials: esters such as polyethylene terephthalate and polyethylene naphthalate; acrylic materials; cycloolefinic materials; olefinic materials; and resins such as polyamide, polyphenylene sulfide, and polycarbonate.

The substrate to which the organic solvent dispersion is applied is preferably a substrate with a hydrophilic surface. When the substrate has a hydrophilic surface, more droplets tend to contact the substrate. As a result, more holes will reach the substrate. Accordingly, it is possible to avoid formation of unnecessary layers of polymers and particles on the bottom of the holes, and therefore is possible to form a conductive film with more through holes. With respect to the substrate with a hydrophilic surface, the contact angle with water is preferably not more than 90°. When the contact angle is not more than 90°, the shape of droplets captured in the organic solvent dispersion can be controlled. As a result, more holes will reach the substrate. The upper limit of the contact angle with water is more preferably not more than 60°, and further more preferably not more than 30°.

The substrate to which the organic solvent dispersion is applied is preferably a substrate whose surface has been subjected to a hydrophilizing treatment. When such a substrate is used, droplets captured in the organic solvent dispersion will be maintained in a suitable shape, as described above. Also, the shape of the conductive film can be more suitably controlled by adjusting the hydrophilicity of the substrate surface. The hydrophilizing treatment is not particularly limited, and is preferably performed by immersing the substrate in an alkaline solution. The alkaline solution is not particularly limited, and is preferably a potassium hydroxide solution, a sodium hydroxide solution, or the like. Specifically, saturated ethanol solution of potassium hydroxide is more preferable. The hydrophilizing treatment also may be performed by corona discharge treatment, plasma treatment, UV-ozonization treatment, or the like. Preferably, from these methods, a suitable method is appropriately selected in accordance with the type of the substrate, the type of the organic solvent dispersion, and the like. The contact angle of the hydrophilized substrate is preferably in the above preferable range of the contact angle.

The production process preferably includes the step of firing the film from which the organic solvent has been evaporated. Even after evaporation of the organic solvent, the organic solvent and other materials, which are components of the organic solvent dispersion, may still remain in the mesh lines containing the conductive fine particles. In this case, the conductive fine particles will be separated from each other, and therefore the conductivity will not be provided. In the case that the firing step is performed, the organic solvent is sufficiently evaporated even if the dried film still contains the organic solvent. Therefore, high conductivity will be provided. In addition, in the firing step, the conductive fine particles will be attached to each other, thereby resulting in higher conductivity.

The firing temperature in the firing step is not particularly limited and changes in accordance with the metal material, the amount of the conductive fine particles, the type of the organic solvent, the film thickness and other factors. For the firing step, these factors can be suitably determined, and the firing temperature is preferably not higher than 400° C. At high firing temperatures, the conductive fine particles will aggregate and therefore will not be combined with each other, thereby resulting insufficient conductivity. The firing temperature is more preferably not higher than 300° C., and further more preferably not higher than 200° C. The firing time is preferably not longer than 2 hours, more preferably not longer than 1 hour, and further more preferably not longer than 30 minutes.

The above-mentioned process for producing a conductive film preferably further includes electroless plating after the step of evaporating the organic solvent while condensing water vapor in air into water droplets on the surface of the applied organic solvent dispersion. The electroless plating step will further improve the conductivity of a conductive film to be produced. In the case that the firing step is performed, the electroless plating step is preferably performed after the firing step.

A conductive film produced by the above-mentioned production process is also one aspect of the present invention. The conductive film produced by the above-mentioned production process has a mesh shape formed by mesh lines made of a conductive material and holes, and therefore has light-transmittance and conductivity. Namely, a transparent conductive film produced by the above-mentioned production process is also one aspect of the present invention. The use of the above-mentioned production process enables low-cost, easy production of light-transmitting conductive films.

With respect to the shape of the conductive film, the average area of the holes is preferably not more than 400 μm², and the mesh lines each preferably have a width of not more than 5 μm. Because the average area of the holes is small and the meth lines are thin, the conductive film has a highly uniform mesh structure with higher light transmittance. Preferable embodiments of the conductive film produced by the above-mentioned production process are the same as the later-described preferable embodiments of a conductive mesh film. Specifically, the average area of the holes is more preferably not more than 300 μm², and further more preferably not more than 200 μm², and particularly preferably not more than 100 μm². The average maximum Feret's diameter of the holes is preferably not more than 20 μm, and more preferably not more than 10 μm. The aperture ratio determined by the holes is preferably not less than 60%. When the aperture ratio is within this range, the light transmittance of the conductive film will be higher. The aperture ratio determined by the holes is more preferably not less than 65%, further more preferably not less than 70%, still further more preferably not less than 80%, and particularly preferably not less than 90%. The width of the mesh lines is more preferably not more than 2 μm, and further more preferably not more than 1 μm. Here, the “maximum Feret's diameter” means the length of the longest line among lines between two parallel lines that touch the contour of a hole at a point, and the “average maximum Feret's diameter” means the average of the measured maximum Feret's diameters of the holes.

The present invention also provides a conductive film having a mesh shape. The mesh shape is formed by mesh lines made of a conductive material and holes, an average area of the holes is not more than 400 μm², and the mesh lines each have a width of not more than 5 μm. Because the average area of the holes is small and the meth lines are thin, the conductive film has a highly uniform mesh structure with higher light transmittance. For example, as described above, when this film is used for electric paper or the like, a voltage can be uniformly applied to microcapsules for display. If a conductive film having a coarse mesh pattern (i.e. the area of the holes is large) is used in a display such as electric paper in which the color of microcapsules is changed by a voltage applied through the conductive film, some microcapsules completely fall in the holes, and to these capsules, a voltage will not be applied. Therefore, a fine mesh structure is required. With a fine mesh pattern, the film exhibits uniform conductivity. Accordingly, when the film is used, for example, in a touch panel, the position recognition accuracy will be high. Such a conductive mesh film can be produced by the process for producing a conductive film described above. In the conductive film, the mesh lines and the holes may be arranged at random or in a regular pattern. When a mesh conductive film with a finer mesh structure is produced, a design in which mesh lines and holes are arranged makes the production easier. Thus, a film in which mesh lines and holes are arranged at random is also one preferable embodiment. The phrase “mesh lines and holes are arranged at random” means a state in which the mesh lines and the holes are not arranged in a certain pattern.

Conductive films are regarded to have a fine mesh structure when the average area of the holes is not more than 400 μm², and the mesh lines each have a width of not more than 5 μm. Since the conductive film has a fine mesh structure, the conductivity of the surface is uniform. If the average area of the holes is more than 400 μm², the conductivity of the surface of the conductive film is not sufficiently uniform, for example, resulting in variations in the light transmittance and conductivity. As described above, when the film is used in displays such as electric paper, a voltage cannot not be applied to some parts and therefore the film may not sufficiently function as a conductive film. The average area of the holes is more preferably not more than 300 μm², further more preferably not more than 200 μm², and particularly preferably not more than 100 μm². The average maximum Feret's diameter of the holes is preferably not more than 20 μm, and more preferably not more than 10 μm. The width of the mesh lines is not more than 5 μm, and this small width enables, for example, prevention of moiré patterns which may occur on displays and the like. If the width of the mesh lines is more than 5 μm, the aperture ratio is small, and therefore the light transmittance may not be sufficient. The width of the mesh lines is more preferably not more than 2 μm, and further more preferably not more than 1 μm. As described above, the light transmittance and conductivity of the conductive film can be controlled to suitable levels by adjusting the average area of the holes and the width of the mesh lines.

The aperture ratio of the conductive film determined by the holes is preferably not less than 60%. Films with a higher aperture ratio have higher light transmittance, and such films are suitably used in displays such as electric paper. If the aperture ratio is less than 60%, the light transmittance may be insufficient, and therefore the film may not sufficiently function as a conductive film with transmittance. The aperture ratio determined by the holes is more preferably not less than 65%, further more preferably not less than 70%, and still further more preferably not less than 80%, and particularly more preferably not less than 90%.

The aperture ratio, the line width, the average area of the holes, and the average maximum Feret's diameter can be determined by the following methods.

### <How to Determine Aperture Ratio, Line Width, Average Area of Holes, and Average Maximum Feret's Diameter>

The aperture ratio of the conductive film, the line width, the average area of the holes, and the Feret's diameters are determined by observing the surface of the conductive film at a magnification of 1000× with an ultra-high resolution field emission scanning electron microscope (S-4800, product of Hitachi High-Technologies Corp.); and processing the observed image using an image-processing software (Image-Pro Plus ver. 4.0, product of Media Cybernetics, U.S.) by the following methods.

The image obtained by the microscopic observation (referred to as “original image”) is binarized into black and white using the image-processing software so that a conductive part becomes black and other parts (holes of the mesh pattern) become white. The threshold value of binarization is defined as the intermediate value of the peaks of black and white determined from the color histogram. Next, the binarized image is subjected to black/white conversion processing (the image obtained through this processing is referred to as “binarized image”). Then, the aperture ratio is determined as the ratio of the area of the black parts to the total area.

The area of the while parts in the binarized image is also determined, and this area is defined as the area (S) of the conductive part. Next, the binarized image is subjected to thinning processing (the image obtained through this processing is referred to as “thinning processed image”). The area of the white part of the thinning processed image is determined as the length (L) of the conductive part. From the values S and L determined above, the width of the conductive part is determined by the following equation (1).

Line width of conductive part=S/L (1)

Subsequently, the black parts in the binarized image are extracted (the image obtained through this step is referred to as “extracted image”). Holes on the boundary are not extracted. Holes with an area of not more than 1 μm² were also not extracted. Then, the area and the maximum Feret's diameter of each element were determined, and the average values of the area and the maximum Feret's diameter were determined as the average area of the holes and the average maximum Feret's diameter of the holes, respectively.

The thickness of the mesh lines is preferably not less than 200 nm. When the thickness is not less than 200 nm, sufficient conductivity will be ensured even if the line width is small. If the thickness of the conductive film is less than 200 nm, the conductivity will be low and the film may not sufficiently function as a conductive film. The thickness of the mesh lines is more preferably not less than 1 μm. The thickness of the mesh lines can be determined by measuring the maximum thickness using, for example, a laser microscope. The measurement is performed by observing the coat at magnification of 50× with a laser microscope (VK-9700, product of KEYENCE Corp.); and measuring the largest level difference of the coat at ten points in the observed image. The average of the obtained values is determined as the maximum thickness of the conductive film.

The transmittance of the conductive film for visible light (wavelength: 400 to 700 nm) is preferably not less than 20%. With a higher light transmittance, the film can be suitably used in display devices such as electric paper. The light transmittance is more preferably not less than 40%, still more preferably not less than 60%, and particularly preferably not less than 80%. For example, the light transmittance for visible light with a wavelength of 300 to 800 nm can be measured using a spectrum photometer (trade name: V-530, product of Jasco Corp.).

The total light transmittance of the conductive film is preferably not less than 20%. When the total light transmittance is not less than 20%, the film can be suitably used in display devices such as electric paper. The total light transmittance is more preferably not less than 40%, still more preferably not less than 60%, and particularly preferably not less than 75%.

The total light transmittance can be measured, for example, using Hayes meter NDH5000 (product of Nippon Denshoku Industries) in accordance with JIS K7361-1.

When the area of the mesh lines is small, films having a higher aperture ratio determined by holes have a higher resistance than films having the same thickness but a lower aperture ratio. Therefore, the area of the mesh lines is preferably at a sufficient level to ensure sufficient conductivity. The preferable area of the mesh lines changes in accordance with the thickness and the area of the conductive film and the metal material in the conductive film. For example, the area of the mesh lines is preferably set such that the sheet resistance of the surface of the conductive film is not more than 10⁵ Ω/sq. The sheet resistance of the conductive film is more preferably not more than 10³ Ω/sq, further more preferably not more than 10² Ω/sq, and particularly preferably not more than 10 Ω/sq.

The sheet resistance can be measured, for example, by a four-terminal four-probe method using a resistance meter, Loresta GP (product of Mitsubishi Chemical Analytic Co., Ltd., probe: ASP type probe).

The conductive material is not particularly limited as long as it is conductive. Examples thereof include metals, conductive inorganic oxides, carbon-containing materials, and carbide-based materials. The metals may be any of various types of metals and may be any of simple metals, alloys, solid solutions, and the like. The simple metals are not particularly limited and examples thereof include various metals such as platinum, gold, silver, copper, aluminum, chromium, cobalt, and tungsten. Among these, highly conductive metals are preferable. Preferable examples of the highly conductive metals include metals containing at least one selected from the group consisting of platinum, gold, silver, and copper. Preferable examples of the metals include metals with high chemical stability. For example, in the case of the process for producing a conductive film described above, steps of dispersing the conductive fine particles in the organic solvent and drying the organic solvent are performed. Therefore, metals capable of avoiding oxidization, corrosion, and the like in these steps are preferable. For high chemical stability, the metals preferably contain at least one selected from the group consisting of platinum, gold, and silver. Among these, for cost savings, metals containing silver are preferable. Examples of the conductive inorganic oxides include indium-containing oxides such as indium tin oxide; transparent conductive materials such as zinc oxide-based oxides; and non-transparent conductive inorganic oxides. Examples of the carbon-containing materials include carbon black. The mesh lines may contain nonconductive materials. For example, the mesh lines may be formed by sintering fine particles in which a non-conductive fine material is covered with a conductive material (e.g. metal, conductive inorganic oxide, carbon-containing material, carbide-based material) (e.g. fine particles with a core-shell structure composed of a “non-conductive material” (core) and a “conductive material” (shell)).

The application fields of the conductive film are not particularly limited and the film can be used for any purpose that requires the conductivity. The conductive film can be used, for example, as an electromagnetic wave shield film (EMI shield film) for plasma displays, and in electric paper (digital paper) and electrodes in display devices of liquid crystal displays. The conductive film can also be used in touch panels and the like.

Thus, the present invention also provides a conductive film used for digital paper.

### Effects of the Invention

The process for producing a conductive film of the present invention enables low-cost, easy production of conductive mesh films that have a fine mesh structure with a remarkably uniform surface and is excellent in the light transmittance. Such conductive films with a fine mesh structure can be suitably used in displays such as electric paper. Owing to their highly uniform surface, these films can prevent moiré patterns when used in displays and the like.

### BRIEF DESCRIPTION OF THE DRAWINGS

FIG. 1-1 is a schematic view illustrating a transition of the cross-section of a coat of an applied organic solvent dispersion over time in one example of the step of evaporating an organic solvent while condensing water vapor in air into water droplets on the surface of the coat.

FIGS. 1-2(a)-(e) are schematic views illustrating the step of evaporating the organic solvent while condensing water vapor in air into water droplets on the surface of the applied organic solvent dispersion.

FIG. 2 is a plane view schematically illustrating a conductive mesh film in which holes and mesh lines are formed.

FIG. 3 is a cross-sectional view schematically illustrating a process in which the organic solvent is evaporated while the substrate and the coat are cooled with a Peltier device and a humidifying gas is being sprayed to the coat.

FIG. 4 are optical-microscopic images each showing the shape of the film before and after firing. FIGS. 4(a-1) and 4(a-2) are views of the film taken before firing at magnifications of 20× and 100×, respectively. FIGS. 4(b-1) and 4(b-2) are views of the film taken after firing at 200° C. for 1 hour, at magnifications of 20× and 100×, respectively. FIGS. 4(c-1) and 4(c-2) are views of the film taken after firing at 300° C. for 30 minutes, at magnifications of 20× and 100×, respectively. FIGS. 4(d-1) and 4(d-2) are views of the film taken after firing at 400° C. for 30 minutes, at a magnification of 20× and 100×, respectively.

FIGS. 5 are electron microscopic images showing the shape of the film before and after firing. FIG. 5(a) is a view of the film before firing. FIG. 5(b) is a view of the film after firing for 1 hour at 200° C. FIG. 5(c) is a view of the film after firing for 30 minutes at 300° C. FIG. 5(d) is a view of the film after firing for 30 minutes at 400° C.

FIG. 6 is an electron microscopic image of the film taken after firing for 1 hour at 200° C. at a lower magnification.

FIG. 7 is an original image of the film which was fired for 1 hour at 200° C.

FIG. 8 is a binarized image of the film which was fired for 1 hour at 200° C.

FIG. 9 is a thinning processed image of the film which was fired for 1 hour at 200° C.

FIG. 10 is an extracted image of the film which was fired for 1 hour at 200° C.

FIG. 11 is a view schematically illustrating a method for measuring a surface profile image and a current image by AFM.

FIG. 12(a) is an AFM surface profile image of the film which was fired for 1 hour at 200° C., and 12(b) is an AFM current image thereof.

FIG. 13(a) is an AFM surface profile image of the film which was fired for 30 minutes at 400° C., and 13(b) is an AFM current image thereof.

FIG. 14 is a graph illustrating the measured results of the transmittance of the obtained conductive film.

FIG. 15 is an optical microscopic image showing the shape of the film of Reference Example 1 after firing (magnification 3000×).

FIG. 16 is an image view of a digital paper of Example 8 when a voltage is applied thereto.

FIG. 17 is an image view of a digital paper of Comparative Example 2 when a voltage is applied thereto.

### MODE FOR CARRYING OUT THE INVENTION

The following description will discuss the present invention in more detail with reference to Examples; however, the present invention is not limited only to those Examples. Meanwhile, “part (s)” means “part (s) by weight” and “%” means “% by mass”, unless otherwise stated.

<Method of Preparing Conductive Fine Particle Dispersion Solution (x-1)>

A 1 L-beaker having 148.1 g of Octylamine (product of Wako Pure Chemical Industries Ltd.) therein was placed in a thermostatic bath set at 40° C. Next, 18.6 g of silver acetate (product of Wako Pure Chemical Industries Ltd.) was added to the beaker and sufficiently mixed by stirring for 20 minutes to prepare a homogenous mixed solution. The mixed solution was reduced by gradually adding 20 g of 20 wt % aqueous sodium borohydride solution.

After the reduction treatment, 200 g of acetone was further added, and the resulting solution was allowed to stand for a while, followed by filtration for isolating and collecting a deposit including silver and organic materials. The collected deposit was added with toluene to be redissolved, cooled to a temperature of 10° C. or lower, and then again filtrated so that a toluene dispersion solution with reduced amount of impurities was prepared. Next, toluene was evaporated by an evaporator to prepare a conductive fine particle dispersion solution (x-1) containing 20 wt % silver particles. The solution contained 9 wt % octylamine and 71 wt % toluene in addition to the silver particles. Observation of the solution with an FE-SEM found that the solution was a nanoparticle dispersion having an average particle size of 4 nm and a particle size distribution of 14% when expressed in terms of a coefficient of variation.

<Method of Preparing Conductive Fine Particle Dispersion Solution (x-2)>

A conductive fine particle dispersion solution (x-2) was prepared in the same manner as the conductive fine particle dispersion solution (x-1), except that benzene was used instead of toluene. The solution contained 20 wt % silver particles, 9 wt % octylamine and 71 wt % benzene. Observation of the solution with FE-SEM found that the solution was a nanoparticle dispersion having an average particle size of 4 nm and a particle size distribution of 14% when expressed in terms of a coefficient of variation.

<Method of Preparing Conductive Fine Particle Dispersion Solution (x-3)>

A conductive fine particle dispersion solution (x-3) was prepared in the same manner as the conductive fine particle dispersion solution (x-1), except that cyclohexane was used instead of toluene. The solution contained 20 wt % silver particles, 9 wt % octylamine and 71 wt % cyclohexane. Observation of the solution with FE-SEM found that the solution was a nanoparticle dispersion having an average particle size of 4 nm and a particle size distribution of 14% when expressed in terms of a coefficient of variation.

### Example 1

### Conditions for Producing Porous Film

Using the conductive fine particle dispersion solution (x-1), a toluene solution containing silver at a weight concentration of 2.5 mg/mL and CAP (n:m=4:1, Mn=99000, Mw=280000) at a weight concentration of 1.0 mg/mL was prepared.

A glass slide was immersed in a saturated potassium hydroxide ethanol solution for two hours, and then subjected to ultrasonic cleansing with water and ethanol for hydrophilization. In this process, the contact angle of the substrate was unmeasurably low, at nearly 0°. About 0.5 mL of the solution was applied on the substrate. The substrate was cooled to 8° C. by a peltier device, and then exposed to humidifying air (relative humidity: 50% or more) blowing at a flow rate of 0.8 m/min for 20 minutes for evaporating the organic solvent, and thereby a dried film was obtained.

### <Drying Condition>

The drying (air-drying) was performed at room temperatures under normal pressures.

### <Firing Condition>

The dried film was placed in an electric furnace in which the temperature was raised at a rate of 10° C./min. under normal pressures and air atmosphere. Three samples were fired respectively under conditions of at 200° C. for one hour, at 300° C. for 30 minutes, and at 400° C. for 30 minutes. The fired samples were allowed to stand for cooling to room temperatures. The maximum film thickness was 1.60 μm for the conductive film before the firing, was 1.07 μm for the conductive film after firing at 200° C. for one hour, and was 0.51 μm for the conductive film after firing at 300° C. for one hour, and was 0.35 μm for the conductive film after firing at 400° C. for one hour.

The maximum film thickness was obtained by observing the coat at a magnification of 50× with a laser microscope (VK-9700, product of Keyence Corporation). The largest level difference of the coat at ten points in the observed image was measured, and the average of the obtained values was determined as the maximum film thickness of the conductive film.

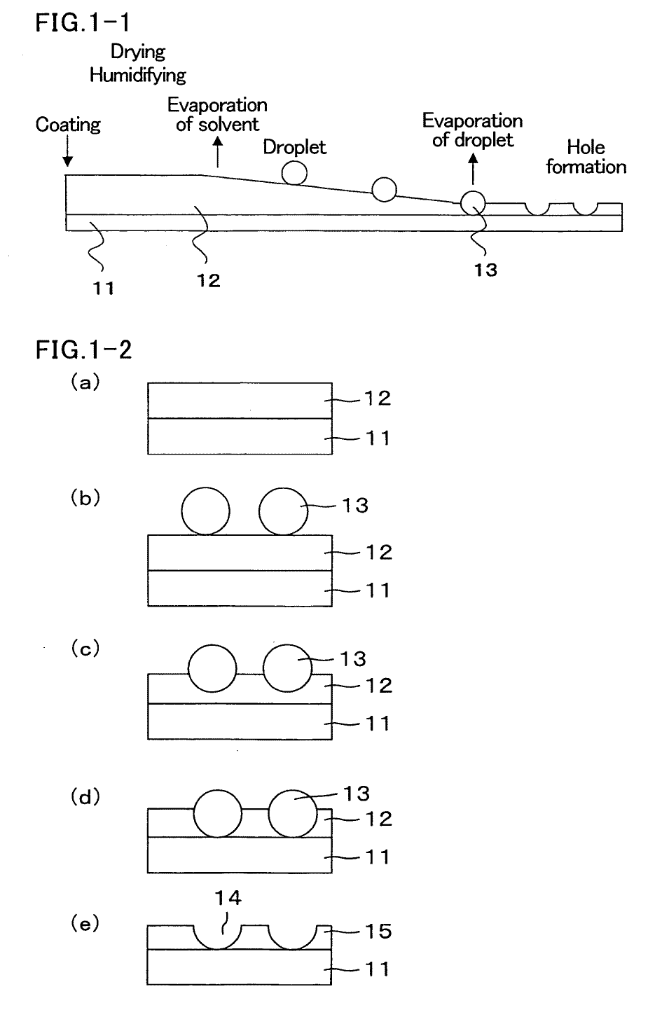

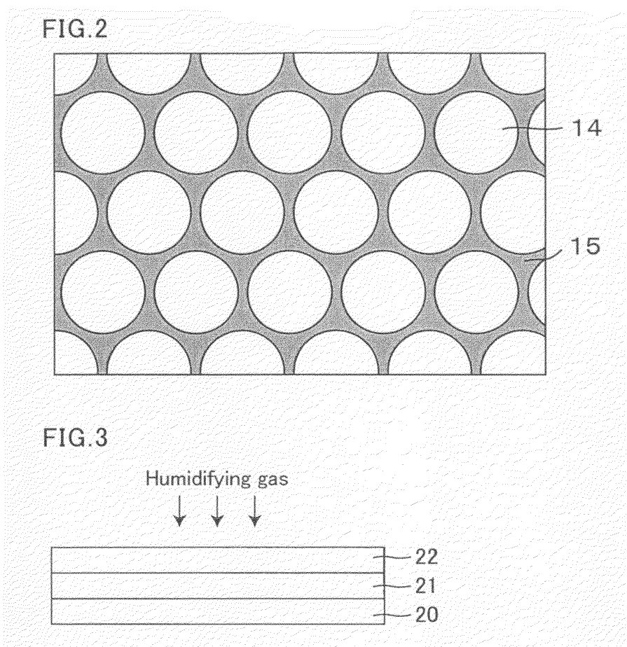

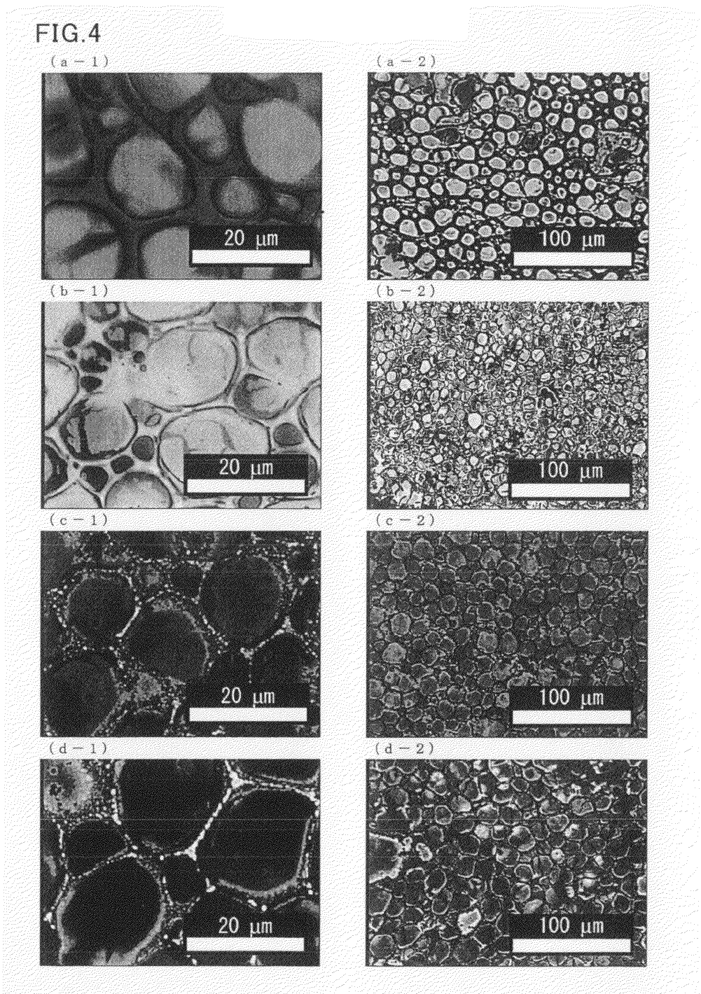

FIGS. 4 are optical-microscopic images each showing the shape of the film before and after firing. FIGS. 4(a-1) and 4(a-2) are views of the film taken before firing at magnifications of 20× and 100×, respectively. FIGS. 4(b-1) and 4(b-2) are views of the film taken after firing at 200° C. for one hour, at magnifications of 20× and 100×, respectively. FIGS. 4(c-1) and 4(c-2) are views of the film taken after firing at 300° C. for 30 minutes, at magnifications of 20× and 100×, respectively. FIGS. 4(d-1) and 4(d-2) are views of the film taken after firing at 400° C. for 30 minutes, at a magnification of 20× and 100×, respectively.

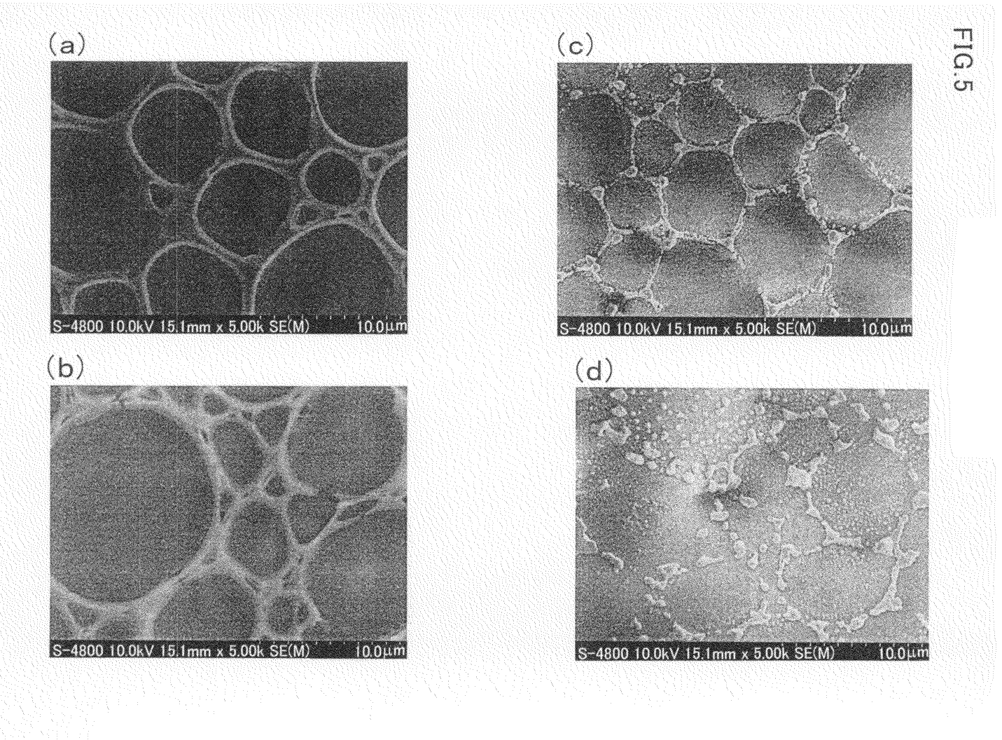

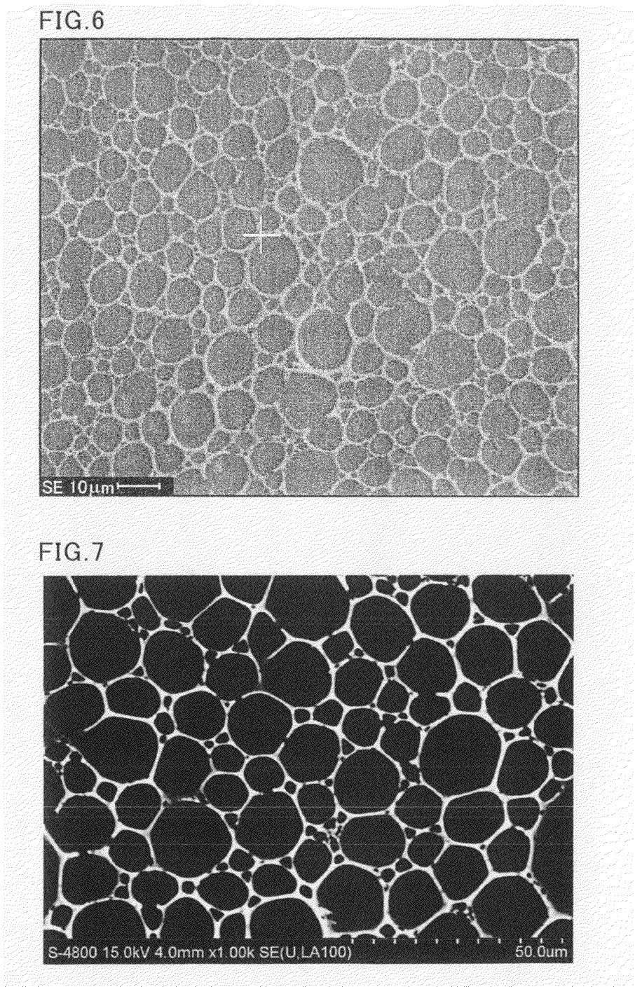

FIGS. 5 are electron microscopic images showing the shape of the film before and after firing. FIG. 5(a) is a view of the film before firing. FIG. 5(b) is a view of the film after firing for one hour at 200° C. FIG. 5(c) is a view of the film after firing for 30 minutes at 300° C. FIG. 5(d) is a view of the film after firing for 30 minutes at 400° C. FIG. 6 is an electron microscopic image of the film taken after firing for one hour at 200° C. at a lower magnification.

The observations with an optical microscope and an electron microscope indicate that all the films before and after firing have become conductive films in which mesh lines and holes are formed. The aperture ratio, line width, average area of the holes, and average Feret's diameter of the holes of the films fired at 200° C. for one hour were determined. The results show that the aperture ratio was 80%, the line width was 1.1 μm, the average area of the holes was 60.4 μm², and the average maximum Feret's diameter of the holes was 8.1 μm. The methods for determining those items are described below.

### <How to Determine Aperture Ratio, Line Width, Average Area of Holes, and Average Maximum Feret's Diameter>

The aperture ratio of the conductive film, the line width, the average area of the holes, and the Feret's diameter were determined by observing the surface of the conductive film at a magnification of 1000× with an ultra-high resolution field emission scanning electron microscope (S-4800, product of Hitachi High-Technologies Corp.); and processing the observed image using an image-processing software (Image-Pro Plus ver. 4.0, product of Media Cybernetics, U.S.) by the following methods.

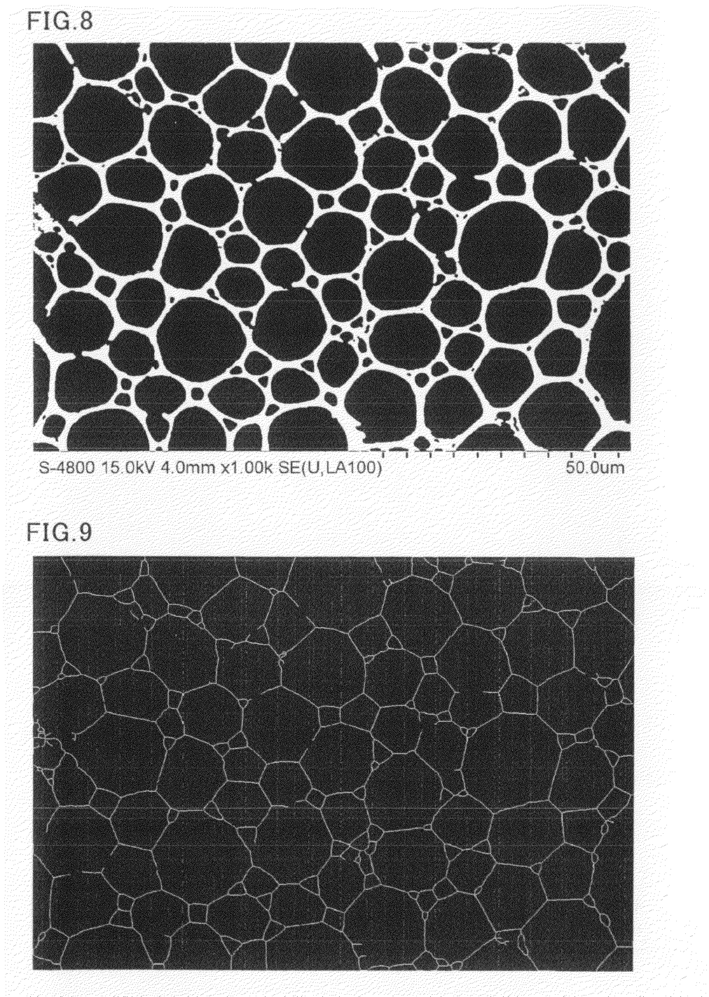

The image obtained by the microscopic observation (referred to as “original image”) was binarized into black and white using the image-processing software so that a conductive part became black and other parts (holes of the mesh pattern) became white. FIG. 7 shows an original image of the film which was fired for one hour at 200° C. The threshold value of binarization was defined as the intermediate value of the peaks of black and white determined from the color histogram. Next, the binarized image was subjected to black/white conversion processing (the image obtained through this processing is referred to as “binarized image”). FIG. 8 shows a binarized image of the film which was fired for one hour at 200° C. Then, the aperture ratio was determined as the ratio of the area of the black parts to the total area.

The area of the while parts in the binarized image was also determined, and this area was defined as the area (S) of the conductive part. Next, the binarized image was subjected to thinning processing (the image obtained through this processing is referred to as “thinning processed image”). FIG. 9 shows a thinning processed image of the film which was fired for one hour at 200° C. The area of the white part of the thinning processed image was determined as the length (L) of the conductive part. From the values S and L determined above, the width of the conductive part was determined by the following equation (1).

Line width of conductive part=S/L (1)

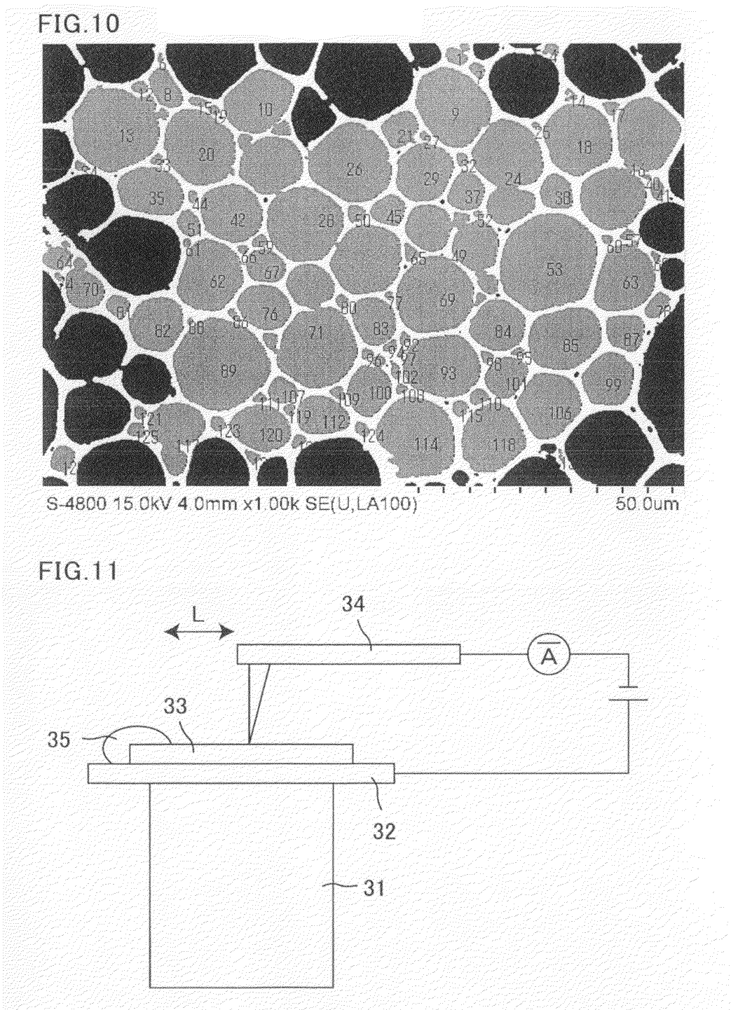

Next, the black part of the binarized image (hereinafter referred to as “extracted image”) was extracted. FIG. 10 shows an extracted image of the film which was fired for one hour at 200° C. The gray portions correspond to the extracted holes (holes counted for averaging), and the black parts correspond to uncounted holes. The numerical figures in FIG. 10 are figures obtained as a result of counting the number of the extracted holes. Holes on the boundary were not extracted in the counting. Holes with an area of not more than 1 μm² were also not extracted. Then, the area and the maximum Feret's diameter of each element were determined, and the average values of the area and the maximum Feret's diameter of the holes were determined as the average area of the holes and the average maximum Feret's diameter of the holes, respectively.

Surface profile images and current images of the fired conductive film were observed with an Atomic Force Microscope (AFM). As a cantilever, SI-AF01A (product of Seiko Instruments Inc.) was used.

### Measuring Conditions

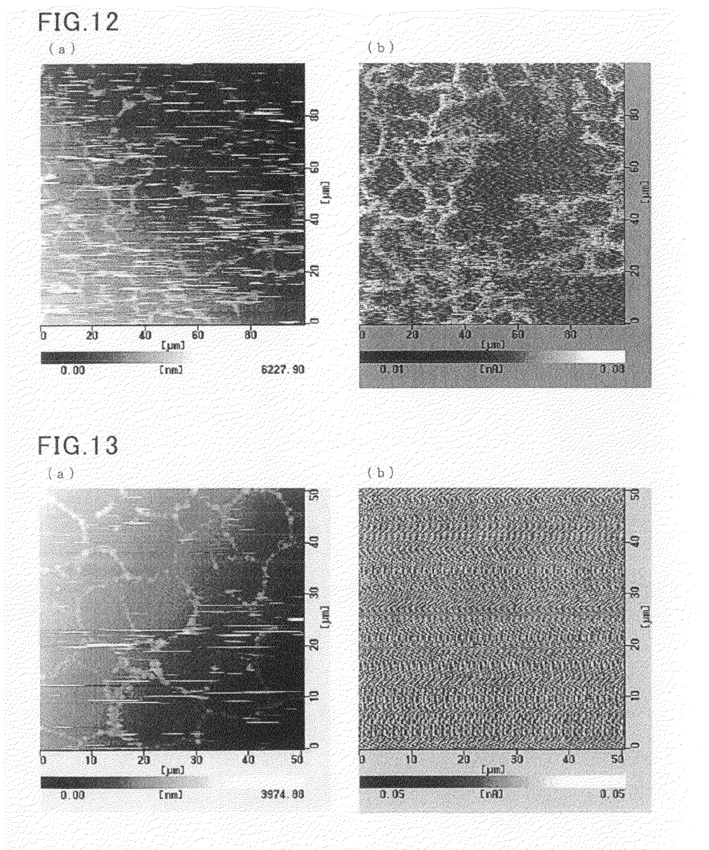

An AFM holder for measuring conductivity (product of Seiko Instruments Inc.) was used for measuring. Samples of the fired films were cut out in a size of about one square centimeter, and the end of each of the samples was fixed with Dotite silver paste. A gold-coated probe was used to apply a bias voltage of 1 to 5 V between the probe and the substrate to simultaneously measure the surface profile image and the current image. The scan range was 50 μm square. FIG. 11 shows a schematic view of an AFM measuring apparatus. As shown in FIG. 11, a sample stage 32 was placed on a piezo stage 31, and a sample 33, in which a conductive film was formed on the substrate, was set on the sample stage 32. Then, the surface profile of the sample was observed by scanning the surface of the sample 33 with the gold-coated probe 34. Additionally, the conductive film on the surface of the sample and the sample stage were connected by the silver paste 35 and a bias of 1 to 5 V was applied between the gold-coated probe 34 and the silver paste 35 to observe the current profile. FIG. 12(a) and FIG. 12(b) show the surface profile image and the current image, respectively, of the film was fired at 200° C. for one hour, which were obtained by AFM measurement. Moreover, FIG. 13(a) and FIG. 13(b) show the surface profile image and the current image, respectively, of the film fired at 400° C. for 30 minutes, which were obtained by AFM measurement.

It is confirmed from the surface profile image of FIG. 12(a) that the film fired at 200° C. for one hour is a film in which holes and the mesh lines are formed. According to the current image, flow of the current was confirmed at the mesh lines. Thus, formation of conductive network due to the mesh lines was confirmed.

It is also confirmed from the surface profile image of FIG. 13(a) that the film fired at 400° C. for 30 minutes is a film in which holes and the mesh lines are formed. However, a conductive network in a desirable condition is not formed due to aggregation of conductive materials and the like, and the current image of FIG. 13(b) did not prove any flow of the current.

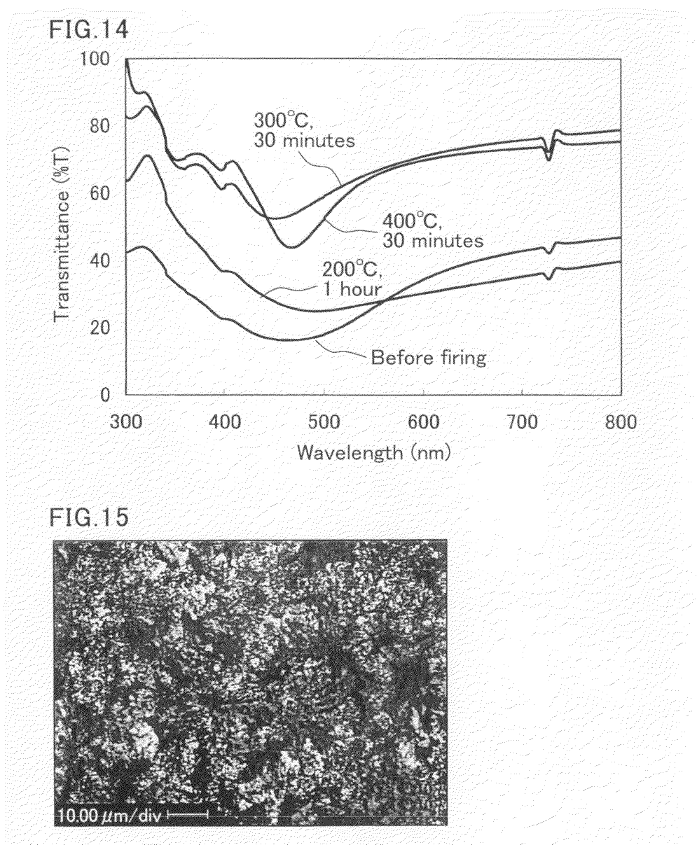

The conductive films before and after firing were evaluated for the transmittance. In the evaluation, the films were evaluated concerning the transmittance for light with a wavelength of 300 to 800 nm by using a spectrophotometer (trade name: V-530, product of Jasco Corp.). FIG. 14 shows the results of the measurement of the transmittance. FIG. 13 is a graph showing the transmittance on the vertical axis and the light wavelength on the horizontal axis. The films fired at 200° C. for one hour had about 20 to 70% transmittance for light with a wavelength of 300 to 700 nm. This may be due to silver left in the holes. For optimization of the production conditions, removal of the silver left in the holes makes it possible to obtain the transmittance at the same level or higher than the aperture ratio of the conductive films in all the wavelength range. The films fired at 300° C. for 30 minutes and the films fired at 400° C. for 30 minutes had the light transmittance of 40 to 90%.

### Example 2

### Condition for Producing Porous Films

A benzene solution containing silver at a weight concentration of 1.0 mg/mL and CAP (n:m=4:1, Mn=99000, Mw=280000) at a concentration of 1.0 mg/mL was prepared using the conductive fine particle dispersion solution (x-2). The solution (2.0 mL) was applied on a 5 cm-square slide glass substrate at 25° C. in a relative humidity of 50%. Humidifying air (relative humidity: 90% or more) was blown to the slide glass at a flow rate of 0.6 m/min for 10 minutes for evaporating the organic solvent, and thereby a dry film was obtained.

### <Drying Condition>

The drying (air-drying) was performed at room temperatures under normal pressures.

### <Firing Condition>

The dried film was placed in an electric furnace, with the temperature raised at a rate of 10° C./min, under normal pressures and air atmospheres, and was fired at 300° C. for 30 minutes. After firing, the film was allowed to stand for cooling to room temperatures. The conductive film had maximum thickness of 0.2 μm, sheet resistance of 8.0×10² Ω/sq., and total light transmittance of 77%. Moreover, the aperture ratio, line width, average area of the holes, and average maximum Feret's diameter of the holes of the conductive films were determined. Table 1 shows the results.

The sheet resistance and the total light transmittance of the conductive film were measured in the following manners.

### <Sheet Resistance>

The sheet resistance of the conductive film was measured by a four-terminal four-probe method using a resistance meter, Loresta GP (product of Mitsubishi Chemical Analytic Co., Ltd., probe: ASP type probe).

### <Total Light Transmittance>

The total light transmittance of the conductive film was measured using Hayes meter NDH5000 (product of Nippon Denshoku Industries) in accordance with JIS K7361-1.

### Example 3

### Condition for Producing Porous Films

A cyclohexane solution containing silver at a weight concentration of 1.0 mg/mL and CAP (n:m=7.6:1, Mn=25000, Mw=95000) at a concentration of 1.0 mg/mL was prepared using the conductive fine particle dispersion solution (x-3). The solution (2.0 mL) was applied on a 5 cm-square slide glass substrate at 25° C. in a relative humidity of 50%. Humidifying air (relative humidity: 90% or more) was blown to the slide glass at a flow rate of 0.6 m/min for 10 minutes for evaporating the organic solvent, and thereby a dry film was obtained.

### <Drying Condition>

The drying (air-drying) was performed at room temperatures under normal pressures.

### <Firing Condition>

The dried film was placed in an electric furnace, with the temperature raised at a rate of 10° C./min, under normal pressures and air atmospheres, and was fired at 300° C. for 15 minutes. After firing, the film was allowed to stand for cooling to room temperatures. The conductive film had maximum thickness of 0.4 μm, sheet resistance of 46 Ω/sq., and total light transmittance of 63%. Moreover, the aperture ratio, line width, average area of the holes, and average maximum Feret's diameter of the holes of the conductive films were determined. Table 1 shows the results.

### Example 4

### Condition for Producing Porous Films

A cyclohexane solution containing silver at a weight concentration of 1.0 mg/mL and EPOMIN RP-20 (octadecyl isocyanate modified polyethyleneimine, product of Nippon Shokubai Co., Ltd., Mn=6500, Mw=13700) at a concentration of 1.0 mg/mL was prepared using the conductive fine particle dispersion solution (x-3). The solution (2.0 mL) was applied on a 5 cm-square slide glass substrate at 23° C. in a relative humidity of 70%. Humidifying air (relative humidity: 70% or more) was blown to the slide glass at a flow rate of 1.5 m/min for 10 minutes for evaporating the organic solvent, and thereby a dry film was obtained.

### <Drying Condition>

The drying (air-drying) was performed at room temperatures under normal pressures.

### <Firing Condition>

The dried film was placed in an electric furnace, with the temperature raised at a rate of 10° C./min, under normal pressures and air atmospheres, and was fired at 200° C. for one hour and then at 150° C. for one hour. After firing, the film was allowed to stand for cooling to room temperatures. The conductive film had maximum thickness of 0.5 pin, sheet resistance of 20 Ω/sq., and total light transmittance of 28%. Moreover, the aperture ratio, line width, average area of the holes, and average maximum Feret's diameter of the holes of the conductive films were determined. Table 1 shows the results.

### Example 5

### Condition for Producing Porous Films

A cyclohexane solution containing silver at a weight concentration of 3.7 mg/mL, and cyclohexyl methacrylate-Praxel FM-1 (caprolactone modified methacrylate) copolymer (molar ratio of cyclohexyl methacrylate: Praxel FM-1=9:1, Mn=25000, Mw=93000) at a concentration of 0.11 mg/mL was prepared using the conductive fine particle dispersion solution (x-3). The solution (2.0 mL) was applied on a 5 cm-square slide glass substrate at 23° C. in a relative humidity of 70%. Humidifying air (relative humidity: 70% or more) was blown to the slide glass at a flow rate of 1.6 m/min for 10 minutes for evaporating the organic solvent, and thereby a dry film was obtained.

### <Drying Condition>

The drying (air-drying) was performed at room temperatures under normal pressures.

### <Firing Condition>

The dried film was placed in an electric furnace, with the temperature raised at a rate of 10° C./min, under normal pressures and air atmospheres, and was fired at 180° C. for 15 minutes. After firing, the film was allowed to stand for cooling to room temperatures. The conductive film had maximum thickness of 0.8 μm, sheet resistance of 3.5×10² Ω/sg., and total light transmittance of 30%. Moreover, the aperture ratio, line width, average area of the holes, and average maximum Feret's diameter of the holes of the conductive films were determined. Table 1 shows the results.

### Example 6

### Condition for Producing Porous Films

A cyclohexane solution containing silver at a weight concentration of 3.7 mg/mL and EPOMIN RP-20 (octadecyl isocyanate modified polyethyleneimine, product of Nippon Shokubai Co., Ltd., Mn=6500, Mw=13700) at a concentration of 0.11 mg/mL was prepared using the conductive fine particle dispersion solution (x-3). The solution (2.0 mL) was applied on a 5 cm-square slide glass substrate at 23° C. in a relative humidity of 70%. Humidifying air (relative humidity: 70% or more) was blown to the slide glass at a flow rate of 1.6 m/min for 10 minutes for evaporating the organic solvent, and thereby a dry film was obtained.

### <Drying Condition>

The drying (air-drying) was performed at room temperatures under normal pressures.

### <Firing Condition>

The dried film was placed in an electric furnace, with the temperature raised at a rate of 10° C./min, under normal pressures and air atmospheres, and was fired at 180° C. for 15 minutes. After firing, the film was allowed to stand for cooling to room temperatures. The conductive film had maximum thickness of 0.9 μm, sheet resistance of 42 Ω/sq., and total light transmittance of 43%. Moreover, the aperture ratio, line width, average area of the holes, and average maximum Feret's diameter of the holes of the conductive films were determined. Table 1 shows the results.

### Example 7

### Condition for Producing Porous Films

A cyclohexane solution containing silver at a weight concentration of 3.7 mg/mL and CAP (n:m=7.6:1, Mn=25000, Mw=95000) at a concentration of 0.11 mg/mL was prepared using the conductive fine particle dispersion solution (x-3). The solution (2.0 mL) was applied on a 5 cm-square slide glass substrate at 23° C. in a relative humidity of 70%. Humidifying air (relative humidity: 70% or more) was blown to the slide glass at a flow rate of 1.6 m/min for 10 minutes for evaporating the organic solvent, and thereby a dry film was obtained.

### <Drying Condition>

The drying (air-drying) was performed at room temperatures under normal pressures.

### <Firing Condition>

The dried film was placed in an electric furnace, with the temperature raised at a rate of 10° C./min, under normal pressures and air atmospheres, and was fired at 180° C. for 15 minutes. After firing, the film was allowed to stand for cooling to room temperatures. The conductive film had maximum thickness of 0.8 μm, sheet resistance of 6 Ω/sq., and total light transmittance of 42%. Moreover, the aperture ratio, line width, average area of the holes, and average maximum Feret's diameter of the holes of the conductive films were determined. Table 1 shows the results.

TABLE 1

| | Example 2 | Example 3 | Example 4 | Example 5 | Example 6 | Example 7 |
|---|---|---|---|---|---|---|
| Maximum film thickness (μm) | 0.2 | 0.4 | 0.5 | 0.8 | 0.9 | 0.8 |
| Aperture ratio (%) | 68 | 65 | 60 | 60 | 62 | 70 |
| Line width (μm) | 0.7 | 0.5 | 0.9 | 1.0 | 0.8 | 1.3 |
| Average area of holes (μm²) | 11.3 | 10.5 | 19.1 | 16.7 | 27.1 | 83.5 |
| Average maximum Feret's diameter of holes (μm) | 4.3 | 4.1 | 5.1 | 4.9 | 5.8 | 8.6 |
| Sheet resistance (Ω/□) | 8.0 × 10² | 46 | 20 | 3.5 × 10² | 42 | 6 |
| Total light transmittance (%) | 77 | 63 | 28 | 30 | 43 | 42 |

### Reference Example 1

### Embodiment in which No Conductive Mesh Film is Formed

### <Condition for Producing Porous Films>

A chloroform solution containing silver at a weight concentration of 2.75 mg/mL was prepared using, as conductive particles, a silver particle dispersion solution (chloroform solution) produced by Mitsuboshi Belting Ltd. The solution (2.0 mL) was applied on a 5 cm-square slide glass substrate at 23° C. in a relative humidity of 70%. Humidifying air (relative humidity: 70%) was blown to the slide glass at a flow rate of 1.6 m/min for 10 minutes for evaporating the organic solvent, and thereby a dry film was obtained.

### <Drying Condition>

The drying (air-drying) was performed at room temperatures under normal pressures.

### <Firing Condition>

The dried film was placed in an electric furnace, with the temperature raised at a rate of 10° C./min, under normal pressures and air atmospheres, and was fired at 300° C. for 15 minutes. After firing, the film was allowed to stand for cooling to room temperatures.

FIG. 15 is an optical microscopic image showing the shape of the film of Reference Example 1 after firing. The optical microscopic observation was performed using a digital microscope VHX-100 (product of Keyence Corporation) at a magnification of 3000×. The observation found irregular projections and depressions on the surface but found no pattern structure.

Meanwhile, in FIG. 15, white parts correspond to projections and black parts correspond to depressions, showing that the surface is covered with the irregular projections and depressions of the silver film. In this case, it is indicated that the surface has no transparency and transmittance.

### Reference Example 2

### Embodiment in which No Conductive Mesh Film is Formed

### <Condition for Producing Porous Films>

A cyclohexane solution containing silver at a weight concentration of 0.2 mg/mL was prepared using the conductive fine particle dispersion solution (x-3). The solution (2.0 mL) was applied on a 5 cm-square slide glass substrate at 25° C. in a relative humidity of 80%. Humidifying air (relative humidity: 80%) was blown to the slide glass at a flow rate of 0.6 m/min for 10 minutes for evaporating the organic solvent, and thereby a dry film was obtained.

### <Drying Condition>

The drying (air-drying) was performed at room temperatures under normal pressures.

### <Firing Condition>

The dried film was placed in an electric furnace, with the temperature raised at a rate of 10° C./min, under normal pressures and air atmospheres, and was fired at 300° C. for 15 minutes. After firing, the film was allowed to stand for cooling to room temperatures.

The shape of the fired film was observed with the digital microscope in the same manner as Reference Example 1. The observation found no pattern structure and found silver thin films formed on the whole surface.

### Reference Example 3

### Embodiment in which No Conductive Mesh Film is Formed

### <Condition for Producing Porous Films>

A cyclohexane solution containing silver at a weight concentration of 0.1 mg/mL and polystyrene (product of Sigma-Aldrich, Co., Mw=280000) at a concentration of 0.2 mg/mL was prepared using the conductive fine particle dispersion solution (x-3). A 5 cm-square glass slide was immersed in a saturated potassium hydroxide ethanol solution for two hours, and then subjected to ultrasonic cleansing with water and ethanol for hydrophilization. In this process, the contact angle of the substrate was unmeasurably low, at nearly 0°. The solution (2.0 mL) was applied on the 5 cm-square slide glass substrate at 25° C. in a relative humidity of 80%. Humidifying air (relative humidity: 80%) was blown to the slide glass at a flow rate of 0.6 m/min for 10 minutes for evaporating the organic solvent, and thereby a dry film was obtained.

### <Drying Condition>

The drying (air-drying) was performed at room temperatures under normal pressures.

### <Firing Condition>

The dried film was placed in an electric furnace, with the temperature raised at a rate of 10° C./min, under normal pressures and air atmospheres, and was fired at 300° C. for 15 minutes. After firing, the film was allowed to stand for cooling to room temperatures.

The shape of the fired film was observed with a digital microscope in the same manner as Reference Example 1. The result showed that pattern structures were only partially formed, and even in the parts with the pattern structures, silver particles were deposited at the bottom of the holes. Therefore, there was no area in which the substrate can be directly observed.

### Comparative Example 1

### Condition for Producing Porous Films

A cyclohexane solution containing silver at a weight concentration of 3.7 mg/mL and EPOMIN RP-20 (octadecyl isocyanate modified polyethyleneimine, product of Nippon Shokubai Co., Ltd., Mn=6500, Mw=13700) at a concentration of 0.11 mg/mL was prepared using the conductive fine particle dispersion solution (x-3). The solution (2.0 mL) was applied on a 5 cm-square slide glass substrate at 23° C. in a relative humidity of 40%. Air (relative humidity: 40%) was blown to the slide glass at a flow rate of 1.6 m/min for 10 minutes for evaporating the organic solvent, and thereby a dry film was obtained.

### <Drying Condition>

The drying (air-drying) was performed at room temperatures under normal pressures.

### <Firing Condition>

The dried film was placed in an electric furnace, with the temperature raised at a rate of 10° C./min, under normal pressures and air atmospheres, and was fired at 180° C. for 15 minutes. After firing, the film was allowed to stand for cooling to room temperatures.

### <Results>

No pattern structure was formed, and the whole surface was coated with silver nanoparticles.

Transmittance: 12%

Conductivity: Could not be measured with Loresta.

As no pattern structure was formed, the transmittance was low. Moreover, the film became thinner than it was when the pattern structure was formed because it was applied on the whole surface, and therefore the conductivity was lost.

### Example 8

A digital paper was produced in the following manner with reference to Comparative Examples described in JP-A2005-338189.

### <TiO₂>

100 g of titanium oxide (trade name: TIPAQUE CR-97, product of Ishihara Sangyo Kaisha Ltd.), 100 g of n-hexane and 4 g of octadecyltrichlorosilane (trade name: LS6495, product of Shin-Etsu Chemical Co., Ltd.) were introduced into a 300 mL 4-necked flask. While, mixing by stirring, the flask was placed in ultrasonic bath (bath in which ultrasonic was generated with an ultrasonic homogenizer (trade name: BRANSON5210, product of Yamato Scientific Co., Ltd.)) set at 55° C. so that coupling agent treatment was performed under ultrasonic dispersion for two hours.

The resulting dispersion liquid was transferred into a precipitation tube for centrifugal separation, and precipitation operation was performed using a separator (trade name: High speed refrigerated centrifuge GRX-220, product of Tomy Seiko Co., Ltd.) at 10000 G for 15 minutes. Thereafter, supernatant in the precipitation tube was removed so that surface-treated titanium oxide (p1) was obtained.

### <CB>

5 g of Carbon black (trade name: MA100, product of Mitsubishi Chemical Corporation) and 172.5 g of methyl methacrylate were charged into a 200 mL beaker, and subjected to dispersion treatment with an ultrasonic homogenizer (trade name: BRANSON5210, product of Yamato Scientific Ltd.). Thereafter, 3.5 g of azobisbutyronitrile was added and dissolved so that a monomer composition was obtained.

A solution of an anionic surfactant (trade name: Hightenol No. 8) (2.5 g) dissolved in water (750 g) was first prepared.

The whole amount of the monomer composition was added to the aqueous solution, followed by dispersion using a high speed emulsification machine (trade name: Clearmix CLM-0.8S, product of M Technique Co., Ltd.) so that a suspension of the monomer composition was obtained.

The suspension was heated to 75° C. and maintained at the temperature for five hours for polymerization so that a dispersion of black particles was obtained. The particle size (volume average particle size) of the black particles was measured using a laser diffraction/scattering particle size distribution analyzer (trade name: LA-910, product of Horiba Ltd.), and the result was 0.8 μm. The dispersion was subjected to filtration, washing, and drying, and thereby black particles (p2) were obtained.

### <Ink Forming>

The black particles (p2) in an amount of 3.1 g and the titanium oxide (p1) in an amount of 11.5 g were added to 85.6 g of Isopar M (product of Exxonmobile Chemical). The mixture was dispersed in an ultrasonic bath for two hours so that a dispersion liquid (i1) for electrophoretic display device was obtained.

### <Encapsulation>

Water (60 g), gum arabic (6 g), and gelatin (6 g) were charged into a 500 mL flat-bottom separable flask and dissolved.

While maintaining the solution at a temperature of 43° C., 95 g of the dispersion liquid (i1) for electrophoretic display device warmed at 50° C. was added to the solution under stirring with a disper (product name: ROBOMICS, product of Primix Corporation). Thereafter, the stirring rate was gradually increased to 1200 rpm and stirring was further performed for 30 minutes to give a suspension. The stirring rate was gradually reduced while adding 300 mL of warm water (43° C.) to the suspension.

Under stirring in which homogenized condition of the solution could be maintained using a paddle-shaped stirring blade, about 11 mL of aqueous acetate solution (10 wt %) was constantly added to the solution by taking 22 minutes to set the pH at 4.0, and then cooled to 10° C.

The suspension was kept in the above cooled state for two hours, and then 3 mL of an aqueous formalin solution (37 wt %) was added to the suspension, followed by constant addition of 22 mL of aqueous Na₂CO₃ solution (10 wt %) by taking 25 minutes.

Next, the temperature of the suspension was returned to normal temperatures and kept for 20 hours for aging so that a dispersion liquid for microcapsules (cm 1) for electrophoretic display device was prepared. The volume average particle size of the microcapsules (cm1) for electrophoretic display device was 51.1 μm.

The dispersion liquid was classified by passing through a mesh with an opening size of 80 μm and a mesh with an opening size of 30 μm so that a paste (solid content: 57 wt %) having particle size of 30 to 80 μm for microcapsules (cm 1) for electrophoretic display device was obtained.

### <Coat>

Next, 2.1 g of an alkali-soluble acrylic resin emulsion (trade name: WR503A, product of Nippon Shokubai Co., Ltd., resin content: 30 wt %) was diluted with water in a manner that the resulting solution had a solid content of 5 wt %, and to this solution was further added 0.2 g of aqueous ammonia (25 wt %) to prepare an alkali-soluble acrylic resin solution. Then, 12.8 g of the resin solution was added to 12.8 g of the aforementioned paste, and they are mixed for 10 minutes with a mixer (trade name: Awatori Rentaro AR-100, product of Thinky) for 10 minutes so that a coat was obtained.

### <Application, Lamination>

The coat was applied to a PET film with ITO using an applicator, and dried at 90° C. for 10 minutes so that a sheet (s1) for electrophoretic display device was obtained.

The glass provided with the silver conductive film according to the present invention was laminated on the coated face of the sheet (s1) for electrophoretic display device so that an electrophoretic display device (d1) having counter electrode was prepared.

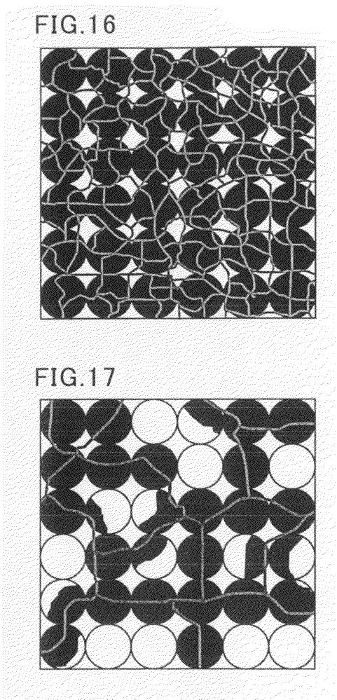

Application of a voltage of 3V to the device (d1) turned the surface of the cathode side white and the surface of the anode side black. When the polarity of the voltage was reversed, each of the colors was reversed as well, showing that the conductive film of the present invention can be used as a transparent electrode for a digital paper. FIG. 16 shows an image view of a digital paper when a voltage is applied to the device (d1).

### Comparative Example 2

A conductive film having silver pattern conductive coat formed on the surface was prepared according to Example 10 in JP-A 2005-530005. The line width of the conductive coat was 3.2 μm, an average area of the holes was 5673 μm², and an average maximum Feret's diameter of the holes was 84 μm. The conductive film, in which the silver conductive film was formed, was laminated on the coated surface of the sheet (s1) for the electrophoretic display device so that an electrophoretic display device (d2) having counter electrode was prepared.

Application of a voltage of 3V to the device (d2) caused electrophoretic migration of only the microcapsules on the silver pattern, and did not cause electrophoretic migration of the microcapsule formed on the area other than the silver pattern. The above state may be expressed schematically as shown in FIG. 17. The whole surface of the film did not become white nor black, and also inhomogeneous black and white patterns were observed at both the cathode side and the anode side. This result indicates that the conductive film according to Comparative Example 2 was not suitable as a transparent electrode for a digital paper.

### EXPLANATION OF SYMBOLS

11, 21: substrate
12, 22: coat (coated organic solvent dispersion)
13: droplet
14: hole
15: mesh line
20: peltier device
31: piezo stage
32: sample stage
33: sample
34: gold-coated probe
35: silver paste

1. A process for producing a conductive mesh film, comprising:
applying an organic solvent dispersion containing conductive fine particles to a substrate; and
evaporating the organic solvent while condensing water vapor in air into water droplets on a surface of the applied organic solvent dispersion.

2. The process for producing a conductive film according to claim 1,
wherein the organic solvent dispersion contains an amphiphilic compound miscible with water and the organic solvent.

3. A conductive film produced by one of the processes according to claim 1.

4. A conductive film having a mesh shape, wherein the mesh shape is formed by mesh lines made of a conductive material and holes,
an average area of the holes is not more than 400 μm², and
the mesh lines each have a width of not more than 5 μm.

5. The conductive film according to claim 3, which is used for digital paper.

6. A conductive film produced by one of the processes according to claim 2.

7. The conductive film according to claim 4, which is used for digital paper.
